(19) United States
(12) Patent Application Publication
(10) Pub. No.: US 2025/0080846 A1
(43) Pub. Date: Mar. 6, 2025

(54) IMAGING APPARATUS

(71) Applicant: Panasonic Intellectual Property Management Co., Ltd., Osaka (JP)

(72) Inventor: Shusaku NAKATA, Osaka (JP)

(73) Assignee: Panasonic Intellectual Property Management Co., Ltd., Osaka (JP)

(21) Appl. No.: 18/809,106

(22) Filed: Aug. 19, 2024

(30) Foreign Application Priority Data
Aug. 31, 2023 (JP) 2023-141054

(51) Int. Cl. H04N 23/68

(52) U.S. Cl. CPC H04N 23/687; H04N 23/6811

(57) ABSTRACT

An imaging apparatus includes: an image sensor that captures a subject image formed via an optical system to generate image data; an optical image stabilizer including at least one of a first image stabilizer moving a correction lens, and a second image stabilizer moving the image sensor; a third image stabilizer that adjusts an area from which an image is cropped; and a controller that controls image stabilization by the image stabilizers, wherein the controller sets a shake correction amount of the optical image stabilizer; and sets a shake correction amount of the third image stabilizer, based on an error amount indicating a difference between the shake correction amount set to the optical image stabilizer and a displacement of the correction lens or the image sensor moved by the optical image stabilizer, and the third image stabilizer performs image stabilization based on the set shake correction amount.

### TECHNICAL FIELD

The present disclosure relates to an imaging apparatus having an image stabilizing function.

### BACKGROUND ART

JP 2019-125890 A discloses an image capturing apparatus in which a correction amount for driving respective image shake correction units of the interchangeable lens and the camera body is calculated, using angular velocity sensors provided in both an interchangeable lens and a camera body. In this image capturing apparatus, the interchangeable lens transmits the first correction amount calculated based on the shake of the image capturing apparatus to the camera body. The camera body acquires the correction error of the second image blur correction unit of the camera body, based on the communication delay of the first correction amount. Then, the camera body performs image blur correction electronically (by image processing) with the electronic image blur correction unit, based on the correction error. It thereby achieves the object to reduce the correction error caused by the communication delay of the first correction amount in the camera body which corrects the image blur using the first correction amount received from the interchangeable lens.

### SUMMARY

The present disclosure provides an imaging apparatus capable of facilitating image stabilization even when significant camera shake occurs.

An imaging apparatus according to one aspect of the present disclosure includes: an image sensor; an optical image stabilizer; a third image stabilizer; and a controller. The image sensor captures a subject image formed via an optical system to generate image data. The optical image stabilizer includes at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis. The third image stabilizer performs image stabilization by adjusting a region from which an image indicated by the image data is cropped. The controller controls the image stabilization by the optical image stabilizer and the third image stabilizer. The controller sets a shake correction amount to be corrected by the optical image stabilizer for an amount of shake of the imaging apparatus. The controller sets a shake correction amount to be corrected by the third image stabilizer, based on an error amount indicating a difference between the shake correction amount set to the optical image stabilizer and a displacement of one of the correction lens and the image sensor moved in the image stabilization by the optical image stabilizer. The third image stabilizer performs the image stabilization based on the set shake correction amount.

An imaging apparatus according to another aspect of the present disclosure includes: an image sensor; an optical image stabilizer; a controller; and an output interface. The image sensor captures a subject image formed via an optical system to generate image data. The optical image stabilizer includes at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis. The controller controls the image stabilization by the optical image stabilizer. The output interface outputs data. The controller sets a shake correction amount to be corrected by the optical image stabilizer for an amount of shake of the imaging apparatus. The controller causes the output interface to output, in association with the image data, the shake correction amount set to the optical image stabilizer, or an error amount indicating a difference between the shake correction amount set to the optical image stabilizer and a displacement of one of the correction lens and the image sensor moved in the image stabilization by the optical image stabilizer.

According to the imaging apparatus of the present disclosure, it is possible to facilitate image stabilization even when significant camera shake occurs.

### BRIEF DESCRIPTION OF DRAWINGS

FIG. 1 is a perspective view of a digital camera according to a first embodiment of the present disclosure;

FIG. 2 is a block diagram showing a configuration of the digital camera according to the first embodiment;

FIG. 3 is a block diagram showing configurations of an IBIS processor and an EIS processor in the digital camera according to the first embodiment;

FIG. 4 is a block diagram showing a configuration of an OIS processor in the digital camera according to the first embodiment;

FIG. 5 is a diagram for illustration of an EIS function in the digital camera according to the first embodiment;

FIG. 6 is a flowchart illustrating an overall operation of image stabilization in the digital camera according to the first embodiment;

FIG. 7 is a flowchart illustrating an operation of the digital camera according to a second embodiment;

FIG. 8 is a flowchart illustrating setting processing of an EIS correction amount in the digital camera according to the second embodiment;

FIG. 9 is a diagram for illustration of an imaging system according to a third embodiment;

FIG. 10 is a block diagram showing a configuration of a digital camera according to the third embodiment;

FIG. 11 is a block diagram showing a configuration of a PC in the imaging system according to the third embodiment;

FIG. 12 is a flowchart illustrating an operation of the digital camera according to the third embodiment;

FIG. 13 is a diagram for illustration of the operation of the digital camera according to a modified example of the first embodiment;

FIG. 14 is a block diagram showing a configuration of a simulator in an imaging system according to a modified example of the third embodiment; and

FIG. 15 is a flowchart illustrating a process of building processing of a correction model in the imaging system according to the modified example of the third embodiment.

### DETAILED DESCRIPTION

Hereinafter, embodiments of the present disclosure will be described with reference to the drawings as appropriate. However, in the detailed description, unnecessary parts in descriptions of the conventional technique and the substantially same configuration may be omitted. This is to simplify the description. In addition, the following description and the accompanying drawings are disclosed so that those skilled in the art can fully understand the present disclosure, and not intended to limit the subject matter of the claims.

### First Embodiment

In a first embodiment, an example of a digital camera having three types of image stabilizing functions will be described as an example of an imaging apparatus.

### 1. Configuration

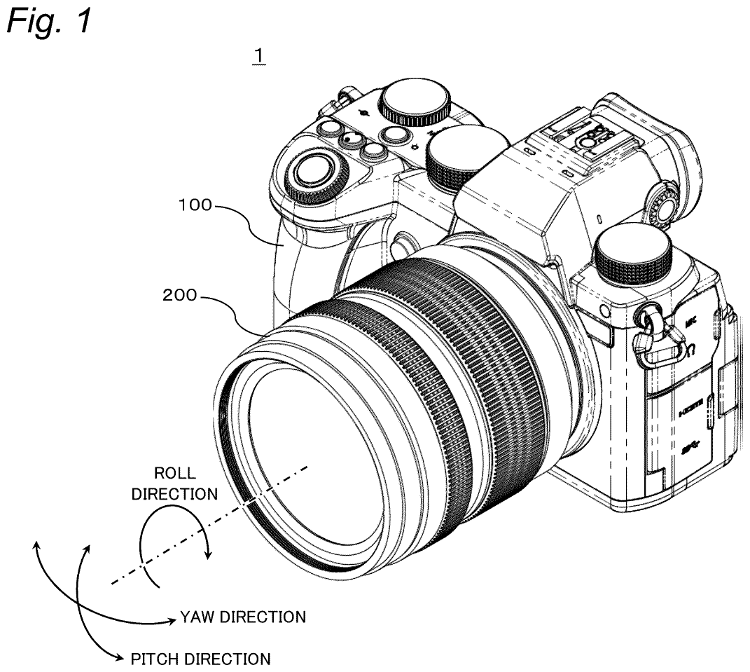

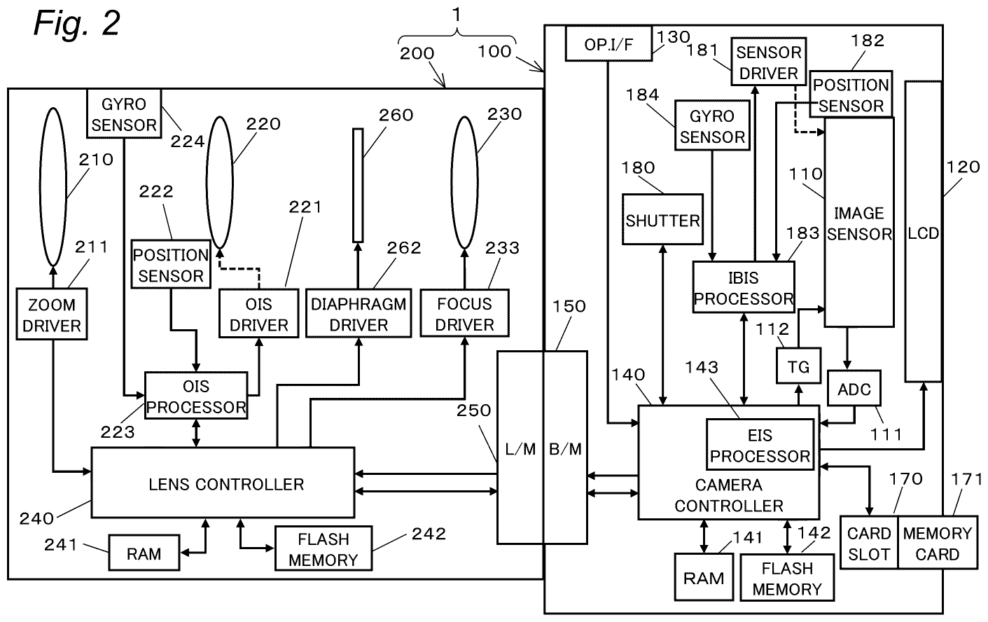

FIG. 1 is a perspective view of a digital camera 1 according to the first embodiment. FIG. 2 is a block diagram showing a configuration of the digital camera 1 according to the first embodiment. The digital camera 1 is an example of an imaging apparatus including a camera body 100 and an interchangeable lens 200 detachable from the camera body 100.

In the following description, a function of correcting shake by moving a correction lens in the interchangeable lens 200 is referred to as an “optical image stabilizer (OIS) function”. Furthermore, a function of correcting shake by moving an image sensor in the camera body 100 is referred to as a “in-body image stabilizer (IBIS) function”. A function of correcting shake by adjusting an area, from which image data captured by the image sensor is cropped, is referred to as an “electronic image stabilizer (EIS) function”.

Further, in the following description, rotation directions corresponding to a horizontal direction and a vertical direction of the image sensor in the digital camera 1 are referred to as a yaw direction and a pitch direction, respectively, and a rotation direction around a rotation axis along an optical axis of the digital camera 1 is referred to as a roll direction (see FIG. 1).

### 1-1. Camera Body

The camera body 100 includes an image sensor 110, a liquid crystal monitor 120, an operation interface 130, a camera controller 140, a RAM 141, a flash memory 142, a body mount 150, a card slot 170, and a shutter 180. Furthermore, the camera body 100 includes an EIS processor 143 that implements an EIS function as a functional configuration of the camera controller 140, for example.

The camera controller 140 controls the entire operation of the digital camera 1 by controlling components such as the image sensor 110 according to an instruction from the release button. The camera controller 140 transmits a vertical synchronization signal to a timing generator (TG) 112. In parallel with this, the camera controller 140 generates an exposure synchronization signal. The camera controller 140 periodically transmits the generated exposure synchronization signal to a lens controller 240 via the body mount 150 and a lens mount 250. The camera controller 140 uses the RAM 141 as a work memory during control operation and image processing operation.

The image sensor 110 is an example of the image sensor that captures a subject image incident through the interchangeable lens 200 to generate image data. The image sensor 110 is, for example, a CCD, a CMOS image sensor, or an NMOS image sensor. The generated image data is digitized by an AD converter (ADC) 111. The digitized image data is subjected to predetermined image processing by the camera controller 140. The predetermined image processing is, for example, gamma correction processing, white balance correction processing, scratch correction processing, YC conversion processing, electronic zoom processing, and/or JPEG compression processing.

The image sensor 110 is operated at a timing controlled by the timing generator 112. The image sensor generates a still image or a moving image, or a through image for recording. The through image is mainly a moving image, and is displayed on the liquid crystal monitor 120 in order for a user to determine a composition for capturing a still image.

The liquid crystal monitor 120 displays various information such as an image such as a through image and a menu screen. The liquid crystal monitor 120 is an example of a display in the present embodiment. Instead of the liquid crystal monitor, another type of display device, for example, an organic EL display device may be used.

The operation interface 130 includes various operation members such as a release button for instructing start of image capturing, a mode dial for setting an image capturing mode, and a power switch. The operation interface 130 also includes a touch panel superimposed over the liquid crystal monitor 120.

The RAM 141 is a recording medium that functions as a work memory of the camera controller 140. The RAM 141 is realized by a dynamic random access memory (DRAM) or the like. The RAM 141 temporarily stores (i.e., holding or buffering), for example, image data generated by the image sensor 110, various types of setting information in the digital camera 1, and the like. The flash memory 142 is a nonvolatile recording medium. For example, the flash memory 142 stores a predetermined setting value and the like in the digital camera 1. Each of the RAM 141 and the flash memory 142 is an example of a storage of the digital camera 1 according to the present embodiment.

The card slot 170 can be inserted with a memory card 171, and the memory card 171 is controlled based on control from the camera controller 140. The digital camera 1 can store image data in the memory card 171, and read the image data from the memory card 171.

The shutter 180 adjusts an exposure time of light incident on the image sensor 110. The shutter 180 is driven by a drive system such as a DC motor or a stepping motor according to a control signal issued from the camera controller 140. For example, the camera controller 140 can control a driving speed (a shutter speed or a continuous shooting speed) at which the shutter 180 is driven.

The body mount 150 can be mechanically and electrically connected to the lens mount 250 of the interchangeable lens 200. The body mount 150 can transmit and receive data to and from the interchangeable lens 200 via the lens mount 250. The body mount 150 transmits the exposure synchronization signal received from the camera controller 140 to the lens controller 240 via the lens mount 250. In addition, other control signals received from the camera controller 140 are transmitted to the lens controller 240 via the lens mount 250. Further, the body mount 150 transmits a signal received from the lens controller 240 via the lens mount 250 to the camera controller 140.

The camera body 100 further includes, as a configuration that realizes the IBIS function, a gyro sensor 184 (shake detector) that detects the vibration of the camera body 100, and an IBIS processor 183 that controls shake correction processing based on a result of the detection of the gyro sensor 184. The camera body 100 further includes a sensor driver 181 that moves the image sensor 110, and a position sensor 182 that detects a position of the image sensor 110.

The sensor driver 181 can be realized by, for example, a magnet and a flat coil. The sensor driver 181 may include another motor, an actuator, or the like. The position sensor 182 is a sensor that detects the position of the image sensor 110 in a plane perpendicular to an optical axis of an optical system. The position of the image sensor 110 may be defined as a position in a two-dimensional plane perpendicular to the optical axis. For example, the position of the image sensor 110 can be defined as a displacement amount along each direction of two orthogonal axes (X-axis and Y-axis) from a predetermined reference position of the image sensor 110. The position sensor 182 can be realized by, for example, three sets of magnets and Hall elements. For example, two of the three sets are arranged in the X-axis direction, the other set is arranged in the Y-axis direction (alternatively, two sets are in the Y-axis direction, and one set is in the X-axis direction), and each of the sets detects a position in the X-axis direction or the Y-axis direction. The position sensor 182 detects each of the positions in the X-axis direction, the Y-axis direction, and the rotation direction by the rotation axis along the optical axis with respect to the reference position of the image sensor 110, from a relationship between results of the detection.

In the position sensor 182, each Hall element is attached to the image sensor 110, and each magnet is fixedly disposed on the camera body 100. As an example, explanation is given for a set of a magnet and a Hall element in the X-axis direction. The Hall element detects a magnetic flux density according to a relative position with respect to the magnet. By preparing a correspondence relationship between a magnitude of the magnetic flux density and the relative position in advance, it is possible to acquire the relative position corresponding to the magnitude of the magnetic flux density detected by the Hall element. The acquired relative position indicates the position of the image sensor 110 in the X-axis direction. For example, the position of the image sensor 110 in the Y-axis direction and the rotation direction can be similarly acquired. As a result, for example, the position sensor 182 outputs a signal indicating the detected position of the image sensor 110 (also referred to as a “position signal”) to the IBIS processor 183.

Based on the signal from the gyro sensor 184 and the signal from the position sensor 182, the IBIS processor 183 controls the sensor driver 181 to shift the image sensor 110 in the plane perpendicular to the optical axis so as to offset shake of the camera body 100. A range in which the image sensor 110 can be driven by the sensor driver 181 is mechanically limited. The range in which the image sensor 110 can be driven by the sensor driver 181 in the IBIS function is referred to as an “element drive range”.

### 1-2. Interchangeable Lens

The interchangeable lens 200 includes an optical system, the lens controller 240, and the lens mount 250. The optical system includes a zoom lens 210, an optical image stabilizer (OIS) lens 220, a focus lens 230, and a diaphragm 260.

The zoom lens 210 is a lens for changing magnification of a subject image formed by the optical system. The zoom lens 210 includes one or a plurality of lenses. The zoom lens 210 is driven by a zoom driver 211. The zoom driver 211 includes a zoom ring that can be operated by the user. Alternatively, the zoom driver 211 may include a zoom lever, and an actuator or a motor. The zoom driver 211 moves the zoom lens 210 along a direction of the optical axis of the optical system according to the operation by the user.

The focus lens 230 is a lens for changing a focus state of a subject image formed on the image sensor 110 in the optical system. The focus lens 230 includes one or a plurality of lenses. The focus lens 230 is driven by a focus driver 233.

The focus driver 233 includes an actuator or a motor, and moves the focus lens 230 along the optical axis of the optical system based on the control of the lens controller 240. The focus driver 233 can be realized by a DC motor, a stepping motor, a servo motor, an ultrasonic motor, or the like.

The OIS lens 220 is a lens for correcting shake of a subject image formed by the optical system of the interchangeable lens 200 in the OIS function. The OIS lens 220 moves in a direction by which the shake of the digital camera 1 is canceled, and thus reduces the shake of the subject image on the image sensor 110. The OIS lens 220 includes one or a plurality of lenses. The OIS lens 220 is driven by an OIS driver 221.

Under the control of an OIS processor 223, the OIS driver 221 shifts the OIS lens 220 in the plane perpendicular to the optical axis of the optical system. A range in which the OIS lens 220 can be driven by the OIS driver 221 is mechanically limited. The range in which the OIS lens 220 can be driven by the OIS driver 221 is referred to as a “lens drive range”. The OIS driver 221 can be realized by, for example, a magnet and a flat coil. A position sensor 222 is a sensor that detects a position of the OIS lens 220 in the plane perpendicular to the optical axis of the optical system, for example, by the similar principle to the position sensor 182 of the camera body 100. The position sensor 222 can be realized by, for example, a magnet and a Hall element. The OIS processor 223 controls the OIS driver 221 based on an output of the position sensor 222 and an output of a gyro sensor 224 (shake detector).

The diaphragm 260 adjusts an amount of light incident on the image sensor 110. The diaphragm 260 is driven by a diaphragm driver 262 so that a size of an opening of the diaphragm 260 is controlled. The diaphragm driver 262 includes a motor or an actuator.

The gyro sensor 184 or 224 detects shake (vibration) in the yaw direction, the pitch direction, and the roll direction based on an angular change of the digital camera 1 per unit time, that is, an angular velocity. The gyro sensor 184 or 224 outputs an angular velocity signal indicating the detected amount of vibration (angular velocity) to the IBIS processor 183 or the OIS processor 223. The angular velocity signal output by the gyro sensor 184 or 224 may include a wide range of frequency components due to camera shake, a mechanical noise, or the like. Instead of the gyro sensor, another sensor capable of detecting shake of the digital camera 1 can be used. In addition, the gyro sensor 224 of the interchangeable lens 200 may not detect shake in the roll direction.

The camera controller 140, the lens controller 240, the OIS processor 223, and the IBIS processor 183 may be configured by a hard-wired electronic circuit, or may be configured by a microcomputer using a program, or the like. For example, the camera controller 140 and the lens controller 240 can be realized by various processors such as a CPU, an MPU, a GPU, a DSU, an FPGA, or an ASIC. Each of the camera controller 140, the lens controller 240, the OIS processor 223, and the IBIS processor 183 is an example of a controller in the digital camera 1 of the present embodiment.

### 1-3. Configuration of Image Stabilizing Function

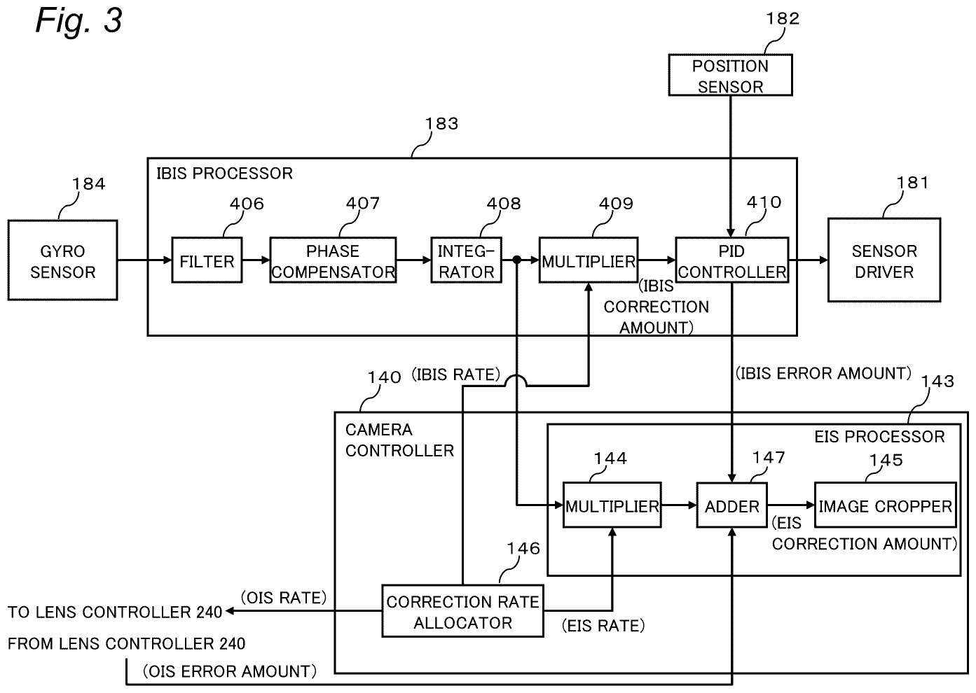

A configuration for realizing various image stabilizing functions of the digital camera 1 in the present embodiment will be described with reference to FIGS. 3 to 5.

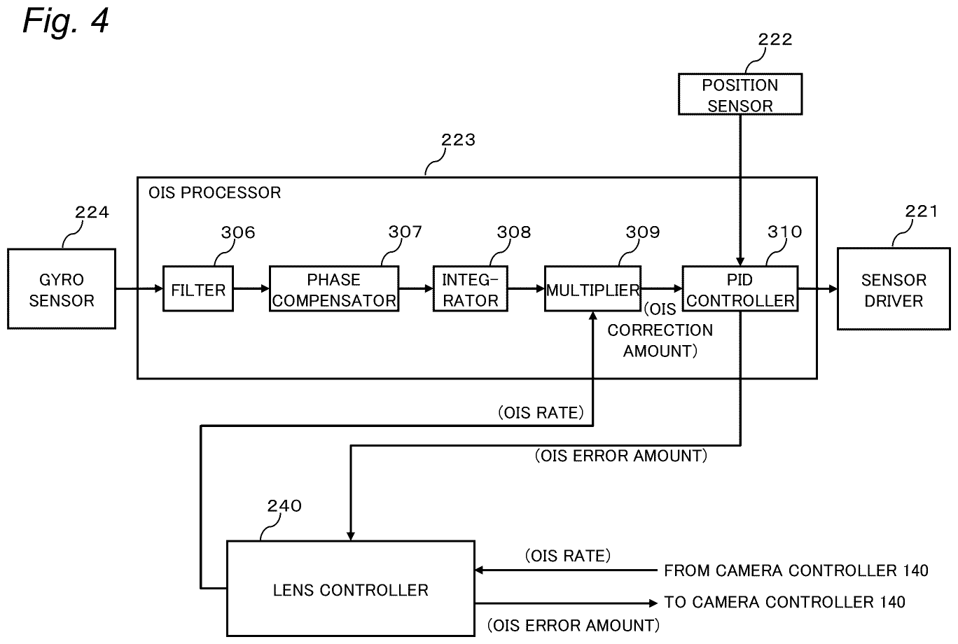

FIG. 3 is a block diagram showing configurations of the IBIS processor 183 and the EIS processor 143 in the digital camera 1 according to the present embodiment. FIG. 4 is a block diagram showing a configuration of the OIS processor 223 in the digital camera 1.

As illustrated in FIG. 3, the digital camera 1 of the present embodiment includes, for example, as a functional configuration of the camera controller 140, the EIS processor 143 that implements an EIS function, and a correction rate allocator 146 that performs setting among various image stabilizing functions. The correction rate allocator 146 of the present embodiment sets, as ratios for distributing a shake correction amount in advance, a correction allocation including an OIS ratio indicating an allocation to the OIS processor 223, a IBIS ratio indicating an allocation to the IBIS processor 183, and an EIS ratio indicating an allocation to the EIS processor 143. In the present embodiment, for example, the digital camera 1 sets the shake correction amount (also referred to as “correction amount”) to be corrected by various image stabilizing functions by the correction rate allocator 146 and the processors 183, 223, and 143.

### 1-3-1. OIS Processor

For example, the correction rate allocator 146 in the camera controller 140 transmits information indicating the OIS ratio to the lens controller 240 of the interchangeable lens 200 via each mount 150, 250, and performs setting for the OIS processor 223.

A configuration of the OIS processor 223 in the interchangeable lens 200 will be described with reference to FIG. 4. The OIS processor 223 includes a filter 306, a phase compensator 307, an integrator 308, a multiplier 309, and a PID controller 310.

The filter 306 applies various kinds of filter processing to a signal received from the gyro sensor 224. The filter 306 includes a high pass filter (HPF), a low pass filter (LPF), a band pass filter (BPF), and/or the like, and blocks a predetermined low frequency component included in the signal by the HPF in order to block a drift component, for example.

The phase compensator 307 corrects a phase delay due to the OIS driver 221 or the like to a signal received from the filter 306.

The integrator 308 integrates a signal received from the phase compensator 307 and indicating the angular velocity of shake (vibration), and generates a shake detection signal indicating the angle of the shake (vibration). The shake detection signal from the integrator 308 is input to the PID controller 310 via the multiplier 309. The OIS processor 223 may use or add a filter configuration other than the above configuration, such as a notch filter for noise processing.

The multiplier 309 multiplies the shake detection signal received from the integrator 308 by, for example, a gain indicating the OIS ratio set by the lens controller 240, and calculates an OIS correction amount as a shake correction amount to be corrected by the OIS function. Each of the OIS ratios in the yaw direction and the pitch direction are set to “0” or more and “1” or less as a gain for the shake detection signal in the corresponding direction. The OIS ratio may be set for each of the directions.

The PID controller 310 performs PID control based on a difference between the OIS correction amount from the multiplier 309 and position information of the OIS lens 220 indicated by the signal from the position sensor 222, and generates a drive signal for the OIS driver 221. The OIS driver 221 drives the OIS lens 220 based on the drive signal.

In the present embodiment, for example, the lens controller 240 acquires, as an OIS error amount, a deviation between the OIS correction amount in the PID control and the position signal from the position sensor 222 from the PID controller 310, in response to a request from the camera controller 140. The OIS error amount indicates a difference between the OIS correction amount and an amount of movement (i.e., displacement) of the OIS lens 220 indicated by the position information of the OIS lens 220 driven according to the OIS correction amount. The lens controller 240 transmits the OIS error amount to the camera controller 140 via each mount 150, 250. Such an error amount will be described later in detail.

### 1-3-2. IBIS Processor

A configuration of the IBIS processor 183 in the camera body 100 will be described with reference to FIG. 3. The IBIS processor 183 includes a filter 406, a phase compensator 407, an integrator 408, a multiplier 409, and a PID controller 410.

The filter 406 applies various kinds of filter processing to a signal received from the gyro sensor 184. The filter 406 includes an HPF, an LPF, and/or a BPF, similarly to the filter 306 of the OIS processor 223, for example.

The phase compensator 407 corrects a phase delay due to the sensor driver 181 or the like to a signal received from the filter 406.

The integrator 408 integrates a signal received from the phase compensator 407 and indicating the angular velocity of shake (vibration), and generates a signal indicating the angle of the shake (vibration) (hereinafter referred to as a “shake detection signal”). The shake detection signal from the integrator 408 is input to the PID controller 410 via the multiplier 409. Here, the IBIS processor 183 may use or add a filter configuration other than the above configuration, such as a notch filter for noise processing.

The multiplier 409 multiplies the shake detection signal received from the integrator 408 by, for example, a gain indicating the IBIS ratio set for the correction rate allocator 146, and calculates an IBIS correction amount as a shake correction amount to be corrected by the IBIS function. For example, the IBIS ratio is separately set for a gain for the shake detection signal in the yaw direction and the pitch direction and a gain for the shake detection signal in the roll direction. In addition to or instead of this, gains may be set in the multiplier 409 separately for the shake detection signal in the yaw direction and the shake detection signal in the pitch direction.

The PID controller 410 generates a drive signal for shifting the image sensor 110 on the basis of an output from the position sensor 182 and an output from the multiplier 409, and outputs the drive signal to the sensor driver 181. The sensor driver 181 drives the image sensor 110 on the basis of the drive signal. For example, the camera controller 140 acquires, as an IBIS error amount, the deviation input to the PID control from the PID controller 410. The IBIS error amount indicates a difference between the IBIS correction amount and the displacement indicated by the position information of the image sensor 110 driven according to the IBIS correction amount by the image stabilizing operation of the IBIS function. The deviation of the PID control is calculated by, for example, the PID controller 410 based on the IBIS correction amount and the position signal from the position sensor 182.

### 1-3-3. EIS Processor

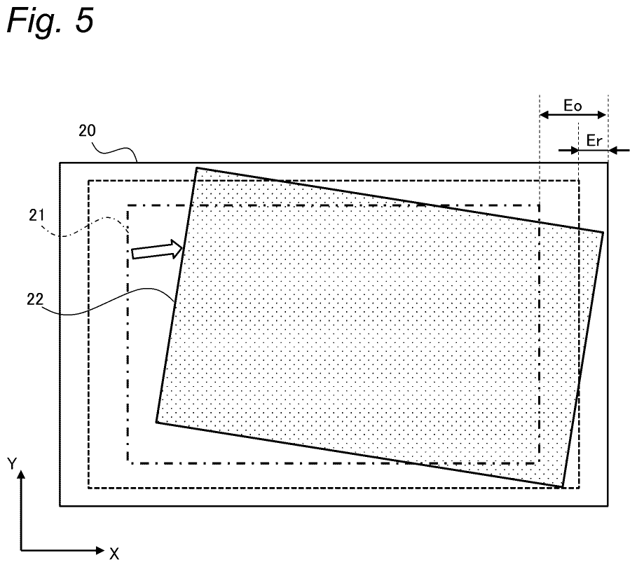

The EIS processor 143 will be described with reference to FIGS. 3 and 5. FIG. 5 is a diagram for illustration of the EIS function in the digital camera 1.

The EIS processor 143 of the present embodiment includes, for example, a multiplier 144, an adder 147, and an image cropper 145 as illustrated in FIG. 3. In the EIS processor 143, for example, a cropping amount Eo is set as illustrated in FIG. 5 by the user's operation on the operation interface 130 or the like using a menu screen in the digital camera 1.

The multiplier 144 multiplies the shake detection signal input from the integrator 408 of the IBIS processor 183 by, for example, a gain indicating the EIS ratio. For example, the EIS ratio is separately set for a gain for the shake detection signal in the yaw direction and the pitch direction and a gain for the shake detection signal in the roll direction. In addition to or instead of this, gains may be set in the multiplier 144 separately for the shake detection signal in the yaw direction and the shake detection signal in the pitch direction.

The EIS processor 143 calculates the shake correction amount based on the shake detection signal received via the multiplier 144. The adder 147 adds, for example, the IBIS error amount acquired from the IBIS processor 183 and the OIS error amount to the calculated shake correction amount, the OIS error amount being acquired from the OIS processor 223 by the lens controller 240, and thus calculates an EIS correction amount as the shake correction amount by the EIS function. Hereinafter, the OIS error amount and the IBIS error amount are also collectively referred to as an “error amount” or “optical error amounts”.

As illustrated in FIG. 5, for example, the image cropper 145 performs processing to crop an image in a narrowed area by the preset cropping amount Eo from the entire image in the image data 20 generated by the image sensor 110. For example, various types of image processing for recording a result of image capturing are performed on the clipped image data. For example, electronic zoom processing may be performed so that the cropped image cropping has the same size as the image before cropping.

The EIS processor 143 realizes the EIS function by adjusting a position where the image is cropped by the image cropper 145 by the calculated EIS correction amount. For example, a reference area 21 is set, in which the cropped image by the image cropper 145 is located when the EIS correction amount is zero, with the center position of the entire image in the image data 20 as a reference. The reference area 21 is arranged, for example, along the horizontal direction X and the vertical direction Y of the image data 20.

The EIS processor 143 translates an image area 22 to be cropped by the image cropper 145 from the reference area 21 in the horizontal direction X according to the shake correction amount in the yaw direction, for example. Similarly, the EIS processor 143 translates the image area 22 in the vertical direction Y according to the shake correction amount in the pitch direction. In addition, the EIS processor 143 rotates a direction of the image area 22 from a direction of the reference area 21 on an XY plane according to the shake correction amount in the roll direction.

The position adjustment of the image area 22 as described above, that is, the EIS function can be executed within a range of the cropping amount Eo. Specifically, the translation of the image area 22 is performed within a range of an amount obtained by removing an amount for the roll as a margin Er from the cropping amount Eo. Further, the rotation of the image area 22 is performed within a range of a rotation angle that falls within the margin Er for the roll in the cropping amount Eo. The margin Er for roll is determined by the correction rate allocator 146 according to the lens state of the interchangeable lens 200, for example.

### 2. Operation

The image stabilizing operation of the digital camera 1 configured as described above will be described below.

In the present embodiment, for example, with a scene that the camera shake is relatively large being assumed, such that the user (e.g., photographer) shoots a moving image while the user is walking or running, the digital camera 1 performs an image stabilizing operation by both or one of the OIS processor 223 and the IBIS processor 183 in combination with the EIS processor 143. The following describes an example in which the OIS processor 223 and the IBIS processor 183 perform the image stabilizing operation in parallel in the digital camera 1, and then the EIS processor 143 performs the image stabilizing operation based on results of the operations performed by the OIS processor 223 and IBIS processor 183. The allocation of the shake correction amounts to be corrected by the respective processors 223, 183, and 143 (i.e., correction allocation) is set in advance, for example.

For example, the OIS processor 223 (FIG. 4) generates shake detection signals in the pitch direction and the yaw direction in the integrator 308 on the basis of the detection result by the gyro sensor 224 of the interchangeable lens 200. The OIS processor 223 calculates, in the multiplier 309, the OIS correction amount based on the shake detection signal and the OIS ratio. The OIS processor 223 controls the OIS driver 221 by a drive signal from the PID controller 310 to drive the OIS lens 220 so as to perform the correction by the OIS correction amount for a shake amount indicated by the calculated shake detection signal.

The IBIS processor 183 (FIG. 3) generates shake detection signals in the pitch direction, the yaw direction, and the roll direction in the integrator 408 on the basis of the detection result by the gyro sensor 184 of the camera body 100. For example, the IBIS processor 183 calculates the IBIS correction amount in each direction based on each shake detection signal and the IBIS ratio in the multiplier 409. The IBIS processor 183 causes the sensor driver 181 to move the image sensor 110 by the drive signal from the PID controller 310 so as to perform the correction by the calculated IBIS correction amounts on the amounts in the pitch direction and yaw direction indicated by the shake detection signal. Further, for the shake amount in the roll direction, the IBIS processor 183 causes the sensor driver 181 to move the image sensor 110 rotationally according to the calculated IBIS correction amount.

In such an optical image stabilizing operation, since the OIS lens 220 or the image sensor 110 with mass is moved, an error may occur between the shake correction amount indicated by the drive signal from the PID controller 310, 410 and an actual displacement of the OIS lens 220 or the image sensor 110. For example, when a moving image or the like is captured, it is conceivable that a change in the displacement lags behind the correction amount sequentially instructed from the PID controllers 310, 410, or the displacement becomes excessive or deficient than the correction amount. In addition, when an external impact or the like is applied to the digital camera 1, an error may occur in which the position of the OIS lens 220 or the image sensor 110 instantaneously deviates from the position corresponding to the correction amount.

Therefore, the digital camera 1 of the present embodiment performs the image stabilizing operation by adding the above error to the image stabilization amount by the EIS processor 143. The EIS processor 143 (FIG. 3) calculates, by the multiplier 144 and the adder 147, the EIS correction amount in each direction on the basis of the OIS error amount and the IBIS error amount attributed to the above described error, in addition to the shake detection signal calculated from the detection result by the gyro sensor 184, for example. The image cropper 145 of the EIS processor 143 translate the image area 22 to be cropped (FIG. 5), so as to perform correction by the calculated EIS correction amounts on the shake amounts in the pitch direction and the yaw direction. For the shake amount in the roll direction, the EIS processor 143 causes the image cropper 145 to rotate the image area 22 according to the calculated EIS correction amount.

According to the above operation of the digital camera 1, even when an error occurs in the actual displacement of the OIS lens 220 or the image sensor 110 compared to the shake correction amount calculated based on the detected shake amount, the EIS processor 143 can perform the image stabilizing operation by the shake correction amount including the error. Therefore, even in a situation where significant camera shake is likely to occur, for example, in a case of shooting by the user running, the image stabilization can be realized to reduce camera shake on an image captured by the digital camera 1 as a whole.

### 2-1. Overall Operation

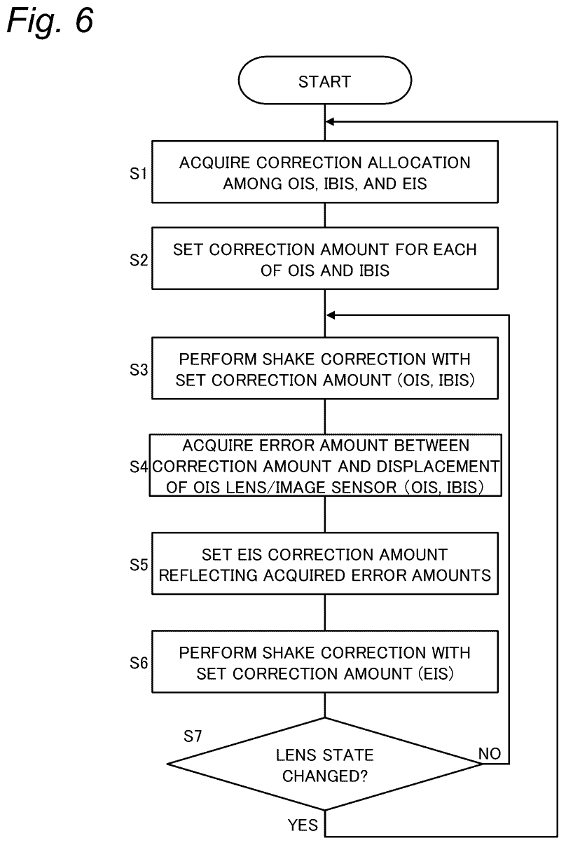

As described above, the digital camera 1 of the present embodiment performs the image stabilizing operation so as to correct, by the EIS function, the error in the OIS function and the IBIS function. An overall operation regarding the image stabilization in the digital camera 1 of the present embodiment will be described with reference to FIG. 6. FIG. 6 is a flowchart illustrating the overall operation of the image stabilization in the digital camera 1 according to the first embodiment.

Each processing illustrated in the flowchart of FIG. 6 is executed by the camera controller 140, the OIS processor 223, and the IBIS processor 183 in parallel with an operation such as shooting moving image, for example, in a state where the interchangeable lens 200 is attached to the camera body 100.

The camera controller 140 acquires information, from the flash memory 142, indicating the correction allocation among the processors 223, 183, and 143 (S1). For example, as information indicating the correction allocation, a predetermined setting value according to a lens state such as a focal length of the interchangeable lens 200 is stored in advance in the flash memory 142.

In the processing of step S1, the camera controller 140 may perform data communication with the lens controller 240 of the interchangeable lens 200 via the body mount 150 and the lens mount 250, to acquire lens state data. The camera controller 140 may acquire, as the correction rate allocator 146, information of the correction allocation according to a lens state indicated by the data. For example, the lens state data includes a focal length according to a zoom state, a focus position according to a focus state of the interchangeable lens 200, and the like, and is stored in the RAM 241 of the interchangeable lens 200. The lens controller 240 reads out the above information in response to a request from the camera controller 140, for example, and transmits the information to the camera body 100.

### (1) Processing Regarding Image Stabilization of OIS/IBIS Functions

As the correction rate allocator 146, the camera controller 140 sets the OIS ratio and the IBIS ratio of the acquired correction allocation to the multipliers 409 and 309 of the OIS processor 223 and the IBIS processor 183, respectively. The OIS processor 223 calculates the OIS correction amount, by multiplication of the OIS ratio in the multiplier 309, on the basis of the shake detection signal according to the detection result by the gyro sensor 224, and sets the OIS correction amount to the PID controller 310 (S2). The IBIS processor 183 calculates the IBIS correction amount, by multiplication of the IBIS ratio in the multiplier 409, on the basis of the shake detection signal according to the detection result of the gyro sensor 184, and sets the IBIS correction amount to the PID controller 410 (S2).

According to the OIS correction amount and the IBIS correction amount set as described above, the OIS processor 223 and the IBIS processor 183 execute the image stabilizing operations (S3). For example, the OIS processor 223 of the present embodiment acquires, from the position sensor 222, the position information of the OIS lens 220 driven by the correction operation, and calculates, as deviation used for the PID control, a difference between a position indicated by the position information and a position of a destination instructed by the OIS correction amount. For example, the OIS processor 223 as the PID controller 310 performs the PID control in the processing of step S3 on an image of a next frame on the basis of the calculated deviation.

In addition, for example, similarly to the OIS processor 223 described above, the IBIS processor 183 acquires the position information of the image sensor 110 from the position sensor 182, and calculates, as a deviation of the PID control, a difference between the position indicated by the position information and the position of a destination instructed by the IBIS correction amount. In the present embodiment, the error amount can be efficiently calculated by using the deviation calculated in the PID control as the error amount.

### (2) Processing Regarding Image Stabilization of EIS Function

The camera controller 140 acquires, for example, the deviation in the PID control as described above as the OIS error amount and the IBIS error amount (S4). For example, the OIS error amount is acquired from the lens controller 240 as a difference between the OIS correction amount and the displacement of the OIS lens 220 for each of the pitch direction and the yaw direction. In response to a request from the camera controller 140, the lens controller 240 acquires the difference from the PID controller 310 of the OIS processor 223 and transmits the difference to the camera body 100.

In step S4, the IBIS error amount is acquired from the PID controller 410 of the IBIS processor 183 as a difference between the IBIS correction amount and the displacement of the image sensor 110 for each of the pitch, yaw, and roll directions, for example. Each error amount may be, for example, a signed value having a different sign depending on a magnitude of the OIS or IBIS correction amount and the displacement of the OIS lens 220 or the image sensor 110.

As the EIS processor 143, for example, the camera controller 140 sets the EIS correction amount on the basis of the OIS error amount and the IBIS error amount in addition to the shake detection signal from the gyro sensor 184 and the EIS ratio of the correction allocation acquired in step S1 (S5). The camera controller 140 adds, in the adder 147, the OIS error amount and the IBIS error amount to the shake correction amount calculated by multiplication of the EIS ratio in the multiplier 144 from the shake detection signal, and calculates the EIS correction amount reflecting each error amount to set the calculated EIS correction amount to the image cropper 145.

In step S5, the camera controller 140 sets the EIS correction amount by converting each of the OIS error amount and the IBIS error amount obtained in units of angles, for example, into magnitude of the error in the image, that is, an error amount in units of pixels. For example, information indicating an arithmetic expression for the conversion may be stored in advance in the flash memory 142 or the like.

As described above, the EIS processor 143 executes the image stabilizing operation according to the EIS correction amount set including the OIS error amount and the IBIS error amount (S6). Therefore, even when an error occurs in the image stabilizing operation by the OIS function and the IBIS function, it is possible to accurately correct the camera shake as the digital camera 1 as a whole using the EIS function.

### (3) Processing According to Lens State

The camera controller 140 periodically acquires the lens state data from the interchangeable lens 200 in the image stabilizing operation (S6), and determines whether or not the lens state changed in the operation, for example (S7). For example, when the user of the digital camera 1 performs a zoom operation or a focus operation on the interchangeable lens 200, the lens state may change. The determination in step S7 is performed on, for example, a change in a focal length of the interchangeable lens 200. The determination in step S7 may also be performed on a change in a focus position.

When it is determined that the lens state did not change (NO in S7), the camera controller 140 returns to processing of step S3 without changing the correction allocation. As a result, the image stabilizing operation using the OIS correction amount and the IBIS correction amount set in step S2 is continued.

On the other hand, when it is determined that the lens state changed (YES in S7), the camera controller 140 performs the processing of step S1 and subsequent steps again according to the lens state. Therefore, the correction allocation according to a new lens state is acquired (S1), and the allocation of the shake correction amounts in the image stabilizing operation can be optimized.

For example, the camera controller 140 repeatedly executes the above processing at a predetermined period. The predetermined period is, for example, a frame period (e.g., from 1/30 seconds to 1/60 seconds).

### (4) Effects and the Like

According to the above processing, the image stabilizing operation can be performed to suppress shake by the EIS function in a captured image, according to the OIS error amount and the IBIS error amount (S3 to S6). For example, in the image stabilizing operation by the OIS function or the IBIS function, especially when the displacement of the OIS lens 220 or the image sensor 110 increases, the shake in the image may also increase due to the error. However, even in such a case, it is possible to suppress the shake in the image by the above processing.

Furthermore, for example, in a case where the displacement of the OIS lens 220 or the image sensor 110 follows behind the correction amount of the OIS or the IBIS calculated sequentially, there may also be an option to improve the followability of the control by increasing the control gain in the PID controller 310, 410. However, in such control, a decrease in control stability in the PID control, an increase of noises due to driving of the OIS driver 221 or the sensor driver 181, and the like can be problematic. According to the digital camera 1 of the present embodiment, an influence of the error in the OIS function and the IBIS function can be reduced using the EIS function, and the image stabilization accurately can be realized while various problems in increasing the gain in the PID control are avoided.

Although an example of acquiring the correction allocation according to the lens state is described above (S1), the correction allocation may be determined with reference to the element drive range in the IBIS function, the lens drive range in the OIS function, the cropping amount Eo in the EIS function, and the like. The element drive range may be stored in advance in the flash memory 142 of the camera body 100, for example, and the lens driving range may be stored in advance in the flash memory 242 of the interchangeable lens 200, for example. The cropping amount Eo may be stored in advance in the flash memory 142, or may be input from the operation interface 130 by the user using a setting menu or the like of the digital camera 1.

The example in which the OIS error amount and the IBIS error amount are respectively acquired from the PID controllers 310, 410 is described above (S4). Each of the error amounts may be calculated, not only based on the deviation in the PID control, but also based on the shake correction amount input to the PID controller 310, 410 and the position information of the OIS lens 220 or the image sensor 110. For example, the camera controller 140 may acquire the OIS correction amount and the position signal from the position sensor 222 in response to a request to the lens controller 240, and calculate the OIS error amount as a difference between the OIS correction amount and the displacement of the OIS lens 220 according to the correction amount. Similarly, the IBIS error amount may be calculated as a difference between the IBIS correction amount and the displacement of the image sensor 110 based on the position signal from the position sensor 182.

In the above description, the example in which the digital camera 1 performs the image stabilizing operation by both the OIS function and the IBIS function in addition to the EIS function is described. The digital camera 1 may execute only one of the OIS function and the IBIS function as the optical image stabilizing operation. For example, the correction rate allocator 146 may set the OIS ratio or the IBIS ratio to “0”, or the digital camera 1 may have only one of the OIS function and the IBIS function. In this case, the digital camera 1 may include only one of the configuration related to the OIS function in the interchangeable lens 200 and the configuration related to the IBIS function in the camera body 100.

Furthermore, in the above example, the processing of FIG. 6 is executed by the camera controller 140, the OIS processor 223, or the IBIS processor 183, but for example, a part or all of the processing may be executed by the lens controller 240. For example, the lens controller 240 may calculate the OIS error amount and transmit the OIS error amount to the camera controller 140 by data communication via each mount 150, 250.

In the above example, the camera controller 140 calculates the OIS error amount for each of the pitch direction and the yaw direction, and calculates the IBIS error amount for each of the pitch direction, the yaw direction, and the roll direction. The camera controller 140 may calculate an error amount only for a part of these directions. In the above example, in the setting of the EIS correction amount, the EIS processor 143 adds each error amount by the adder 147 to the shake correction amount calculated from the shake detection signal. The EIS processor 143 may set the EIS correction amount, not only by the addition by the adder 147, but also by subtraction or addition according to signs of various variables such as the shake correction amount and the error amounts.

### 3. Summary

As described above, the digital camera 1 according to the present embodiment includes the image sensor 110 (image sensor), the optical image stabilizer including at least one of the OIS processor 223 (first image stabilizer) and the IBIS processor 183 (second image stabilizer), the EIS processor 143 (third image stabilizer), and the camera controller 140. In the present embodiment, the OIS processor 223, the IBIS processor 183, and the camera controller 140 are examples of the controller that controls image stabilization by the optical image stabilizer and the third image stabilizer. The image sensor 110 captures a subject image formed via the optical system to generate image data. The OIS processor 223 performs image stabilization by moving the OIS lens 220 included in the optical system in the plane perpendicular to the optical axis of the optical system including the OIS lens 220 (correction lens). The IBIS processor 183 performs image stabilization by moving the image sensor 110 in the plane perpendicular to the optical axis. The EIS processor 143 performs image stabilization by adjusting an area from which an image indicated by the image data is cropped. The OIS processor 223, the IBIS processor 183, and the camera controller 140 set the OIS correction amount and the IBIS correction amount as an example of the shake correction amount to be corrected by the optical image stabilizer for a shake amount (an amount of shake) of the digital camera 1 (S2). The camera controller 140 sets the EIS correction amount as an example of the shake correction amount to be corrected by the EIS processor 143, on the basis of the OIS error amount and the IBIS error amount (S5). The OIS error amount is an example of an error amount indicating a difference between the set OIS correction amount and the displacement of the OIS lens 220 moved in the image stabilization by the optical image stabilizer. The IBIS error amount is an example of an error amount indicating a difference between the set IBIS correction amount and the displacement of the image sensor 110 moved in the image stabilization by the optical image stabilizer. The EIS processor 143 performs the image stabilization by the set EIS correction amount (S6).

According to the digital camera 1 described above, the EIS processor 143 executes the image stabilizing operation by the EIS correction amount set on the basis of the OIS error amount and the IBIS error amount, and thus it is possible to facilitate the image stabilization even when the camera shake occurs significantly.

In the present embodiment, the digital camera 1 includes the gyro sensor 224, 184 as an example of a shake detector that detects the shake amount of the digital camera 1. The OIS processor 223 and the IBIS processor 183 perform the image stabilization on the shake amount detected by the respective gyro sensors 224 and 184, according to the OIS correction amount and the IBIS correction amount respectively set in the processors 223 and 183 (S3). Therefore, each of the processors 223 and 183 executes the image stabilizing operation according to the set correction amount, and thus it is possible to perform optical image stabilization according to the detected amount of shake.

In the present embodiment, the digital camera 1 includes the position sensors 222, 182. The position sensor 222 is an example of a position detector that detects a position of the OIS lens 220 in the plane perpendicular to the optical axis. The position sensor 182 is an example of a position detector that detects a position of the image sensor 110 in the plane perpendicular to the optical axis. The OIS processor 223 and the IBIS processor 183 acquire, based on the detection result of the respective position sensors 222 and 182, at least one of the displacement of the OIS lens 220 and the displacement of the image sensor 110 in the image stabilizing operation of the OIS or IBIS function (S3, S4). Therefore, each of the processors 223 and 183 can calculate an error amount between the correction amount set for the shake amount and corresponding one of the displacements of the OIS lens 220 and the image sensor 110 moved in the image stabilizing operation.

In the present embodiment, the OIS processor 223, the IBIS processor 183, or the camera controller 140 calculates the OIS error amount or the IBIS error amount for at least one of the pitch direction, the yaw direction, and the roll direction in the digital camera 1 as illustrated in FIG. 1 (S4). The pitch direction and the yaw direction correspond to two orthogonal directions in the plane perpendicular to the optical axis. The roll direction corresponds to a rotation direction around the rotation axis along the optical axis. Therefore, the correction by the EIS function according to the OIS and/or IBIS error amount(s) can be performed at least for the direction in which the corresponding error amount is calculated (S5, S6).

In the present embodiment, the digital camera 1 includes the interchangeable lens 200 including an optical system and the OIS processor 223, the camera body 100 including the image sensor 110 and the EIS processor 143, and the lens mount 250 and the body mount 150 each as an example of a communication interface that performs data communication between the interchangeable lens 200 and the camera body 100. The camera controller 140 receives, from the interchangeable lens 200 via the lens mounts 250 and body mount 150, the OIS error amount in the image stabilization by the OIS processor 223 (S4). Alternatively, the lens controller 240 may calculate the OIS correction amount and set the OIS correction amount in the OIS processor 223. The camera controller 140 may acquire the OIS correction amount set in the OIS processor 223 from the interchangeable lens 200.

### Second Embodiment

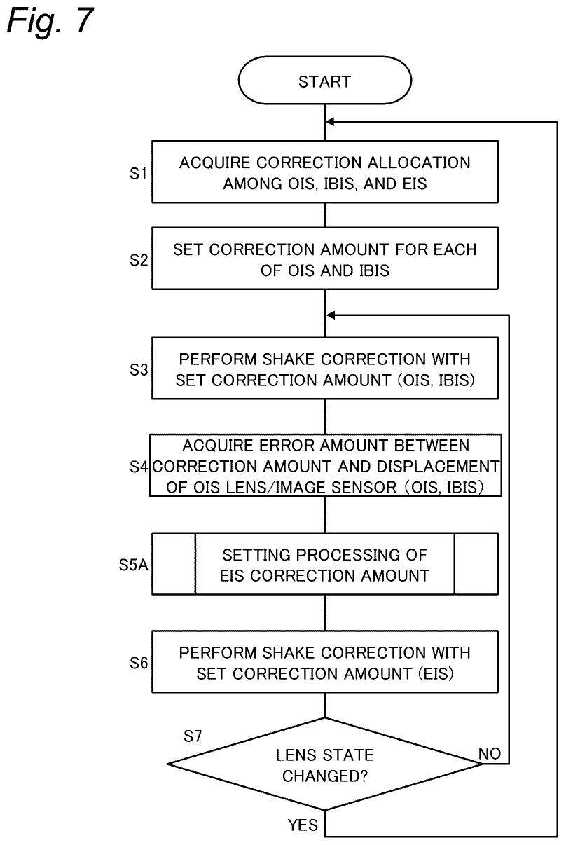

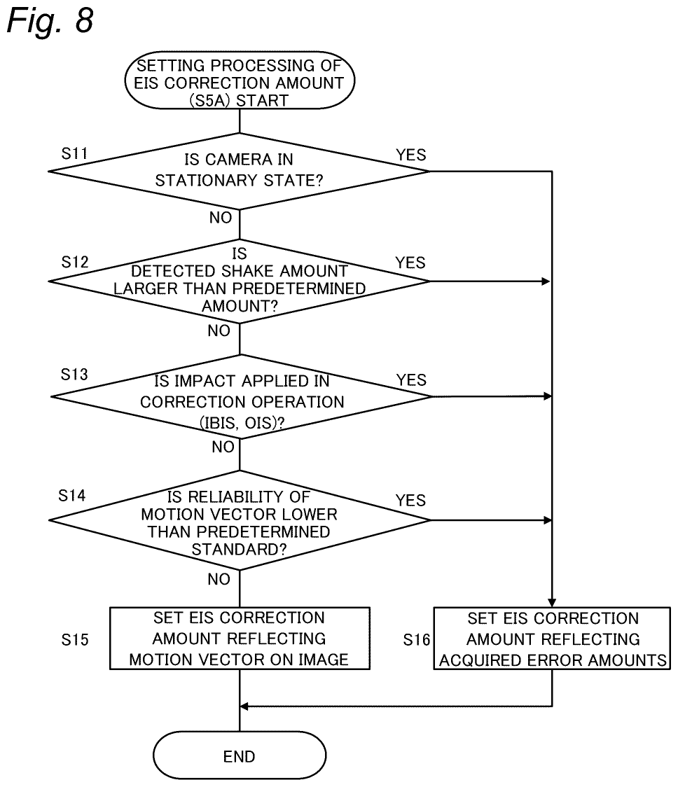

Hereinafter, a second embodiment of the present disclosure will be described with reference to FIGS. 7 and 8. In the first embodiment, the digital camera 1 that performs the image stabilizing operation by the EIS function according to the error with respect to the image stabilization amount in the OIS function and the IBIS function is described. In the second embodiment, the digital camera 1 having an EIS function using a motion vector in an image such as a moving image being captured will be described.

Hereinafter, the digital camera 1 according to the present embodiment will be described while descriptions of the same configuration and operation as those of the digital camera 1 according to the first embodiment are omitted as appropriate.

### 1. Operation

The digital camera 1 of the present embodiment calculates a motion vector, on the basis of the image data sequentially generated by the image sensor 110, for example, during shooting of a moving image, the motion vector indicating a motion between frames in an entire region of the image for each frame indicated by the image data. It is conceivable that such a motion vector of the image reflects shake of the digital camera 1 according to a motion of a subject such as a region or an image object in the image. The camera controller 140 of the present embodiment realizes the image stabilizing operation by the EIS function by setting an EIS correction amount by calculation of the motion vector, in addition to the function as the EIS processor 143 similar to that of the first embodiment.

FIG. 7 is a flowchart illustrating an operation of the digital camera 1 according to the second embodiment. In the overall operation similar to that in the first embodiment, instead of setting the EIS correction amount reflecting the OIS error amount and the IBIS error amount (S5), the digital camera 1 of the present embodiment sets the EIS correction amount by selectively using the error amount and the motion vector of the moving image (S5A). A setting processing of the EIS correction amount (S5A) will be described below with reference to FIG. 8.

### 1-1. Setting Processing of EIS Correction Amount

FIG. 8 is a flowchart illustrating the setting processing of the EIS correction amount (S5A) in the digital camera 1 according to the second embodiment. The processing in this flowchart starts, for example, in a state where the shake amount indicated by the shake detection signal from the gyro sensor 184, which is used to calculate the shake correction amount in step S2 of FIG. 7, and the OIS error amount and the IBIS error amount acquired in step S4 are held in the RAM 141 or the like.

The camera controller 140 determines whether or not the digital camera 1 is in a stationary state based on, for example, the shake amount held in the RAM 141 (S11). The camera controller 140 determines that the digital camera 1 is in the stationary state (YES in S11), for example, when the shake amount is equal to or less than a predetermined amount that can be regarded as the stationary state of the digital camera 1.

When it is determined that the digital camera 1 is in a stationary state (YES in S11), the camera controller 140 sets the EIS error amount reflecting the OIS error amount and IBIS error amount as in step S5 of FIG. 6 in the first embodiment (S16). As described above, in the stationary state, the digital camera 1 of the present embodiment performs the image stabilizing operation by the EIS function so as not to particularly correct a shake due to the movement of the subject on the image, such as the shake reflected to the motion vector. In the stationary state, the digital camera 1 rather performs correction reflecting the OIS and EIS error amounts due to an impact or the like from the outside of the digital camera 1.

On the other hand, when it is determined that the digital camera 1 is not in the stationary state (NO in S11), the camera controller 140 determines whether or not the detected shake amount is larger than a predetermined amount referring to, for example, the RAM 141 (S12). The predetermined amount in step S12 is set in advance, for example, as a shake amount in which a significant error due to a following delay is assumed with respect to the OIS correction amount or the IBIS correction amount sequentially set, the following delay being a delay in which the operation of the OIS lens 220 or the image sensor 110 is delayed in the image stabilizing operation (S3 in FIG. 7).

When the shake amount is larger than the predetermined amount (YES in S12), the camera controller 140 sets the EIS error amount reflecting the OIS and IBIS error amounts (S16). As described above, in a case where the shake amount is relatively large, a significant error due to the following delay of the OIS lens 220 or the image sensor 110 is assumed, and it is likely difficult to accurately calculate the motion vector from the image, so that the correction using the error amount is prioritized over using the motion vector.

When the shake amount is not larger than the predetermined amount (NO in S12), the camera controller 140 determines whether or not an external impact is applied to the digital camera 1 in the image stabilizing operation by the OIS function and the IBIS function (S3 in FIG. 7) (S13). For example, based on the shake amount detected by the gyro sensor 184 or the like in the image stabilizing operation, the camera controller 140 performs the determination in step 13 according to whether or not the shake amount is equal to or larger than a predetermined amount that can be regarded as an external impact.

When it is determined that the impact on the digital camera 1 is applied in the optical image stabilizing operation as described above (S3) (YES in S13), the camera controller 140 sets the EIS error amount reflecting each of the optical error amounts. As described above, in the present embodiment, in a case where the impact on the digital camera 1 is detected, the correction reflecting the error amount in the optical image stabilizing operation is performed to deal with that the error in the operation is likely to increase.

On the other hand, when it is determined that the impact on the digital camera 1 is not applied (NO in S13), the camera controller 140 determines whether or not the reliability of the motion vector obtained at the time of execution of this flowchart is lower than a predetermined standard, for example (S14). For example, when ISO sensitivity is higher than a predetermined value, it is determined that the reliability of the motion vector is lower than the predetermined standard (YES in S13). The predetermined value is set threshold ISO sensitivity by which a ratio (S/N ratio) between noise and a signal indicating the image data from the image sensor 110 can be considered to deteriorate. Furthermore, for example, by calculating a motion vector for each predetermined region (e.g., for each pixel) from each of the frame images in execution of this flowchart and immediately before the execution, the determination in step S13 may be performed according to degree of dispersion of the motion vectors.

When it is determined that the reliability of the motion vector is low (YES in S14), the camera controller 140 proceeds the operation to step S16 and sets the EIS error amount reflecting each of the optical error amounts. As described above, in a case where the reliability of the motion vector is relatively low, it is considered that it is difficult to perform the shake correction accurately by using the motion vector. Therefore, the digital camera 1 of the present embodiment performs the image stabilizing operation by the EIS function reflecting each of the optical error amounts (S16).

When the reliability of the motion vector is not lower than the predetermined standard, that is, when the reliability of the motion vector is relatively high (NO in S14), the camera controller 140 calculates the EIS correction amount on the basis of the motion vector of the image, and sets the correction amount reflecting the motion vector to the image cropper 145 (S15). For example, the camera controller 140 acquires image data sequentially generated by the image sensor 110, and calculates a motion vector by calculating a difference between frames in an image indicated by the acquired image data.

After setting the correction amount using the motion vector or the EIS correction amount using the OIS error amount and the IBIS error amount (S15, S16), the camera controller 140 ends the process of this flowchart. The camera controller 140 executes the image stabilizing operation by the EIS function with the set EIS correction amount (S6 in FIG. 7).

According to the above processing, when the reliability of the motion vector is considered to be relatively high, the EIS correction amount reflecting the motion vector is set (S15). On the other hand, in such a case where the reliability of the motion vector is relatively low, or where the error in the optical image stabilizing operation is assumed to be relatively large, the EIS correction amount reflecting the error amount in the shake correction amount calculated on the basis of the camera shake detection signal and the correction allocation is set (S16). Therefore, in the EIS function, the correction using the motion vector and the correction using the error amount can be selectively executed, and for example, it is possible to accurately perform the image stabilizing operation and to avoid a problem such as mutual interference in a case where both corrections are simultaneously executed.

The above description has described an example in which the predetermined amount in step S12 is an amount in consideration of the following delay of the OIS lens 220 and the like. The predetermined amount is not limited to the above example, and may be set, for example, from the viewpoint of determining whether or not the digital camera 1 is in a state of being able to shoot while walking or running.

In the above description, an example is described in which the presence or absence of an impact on the digital camera 1 is determined on the basis of the shake amount by the shake detection signal from the gyro sensor 184 in step S13. However, the camera body 100 or the like may include an acceleration sensor for detecting the impact, for example. In this case, the camera controller 140 may perform the determination in step S13 according to whether or not the acceleration detected by the acceleration sensor is equal to or greater than the predetermined value that can be regarded as an impact.

### 2. Summary

In the present embodiment, the camera controller 140 calculates the motion vector of the subject image in the image indicated by the image data, on the basis of the image data sequentially captured by the image sensor 110, and sets the EIS correction amount by switching between (i) the EIS correction amount according to the calculated motion vector and (ii) the EIS correction amount according to the OIS error amount and to the IBIS error amount (S5A, S11 to S16). Therefore, for example, even when significant camera shake occurs, the image stabilizing operation of the EIS function can be accurately performed by selectively using the EIS correction amount from the correction amount according to the optical error amounts and from the correction amount according to the motion vector, selecting the EIS correction amount to facilitate correction of the camera shake in the image of the imaging result.

### Third Embodiment

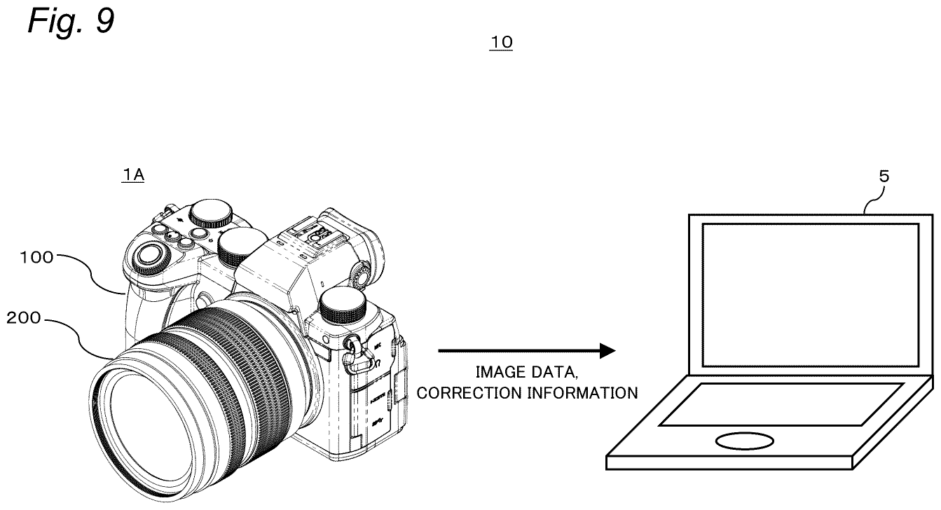

Hereinafter, a third embodiment of the present disclosure will be described with reference to FIGS. 9 to 12. The first and second embodiments has described the digital camera 1 that performs the image stabilization of the EIS function by the camera controller 140 in capturing a moving image or the like. In the third embodiment, a digital camera 1A and an imaging system 10 capable of executing the EIS function in an external information processing device or the like will be described.

Hereinafter, the digital camera 1A and the imaging system 10 according to the present embodiment will be described while descriptions of the similar configuration and operation as those of the digital camera 1 according to the first embodiment and the second embodiment are omitted as appropriate.

### 1. Configuration

FIG. 9 is a diagram for illustration of the imaging system 10 according to the third embodiment. The imaging system 10 includes the digital camera 1A and a personal computer (PC) 5 as an example of an information processing device. The imaging system 10 is configured to be able to perform data communication for transferring image data, each of the error amounts, and the like from the digital camera 1A to the PC 5.

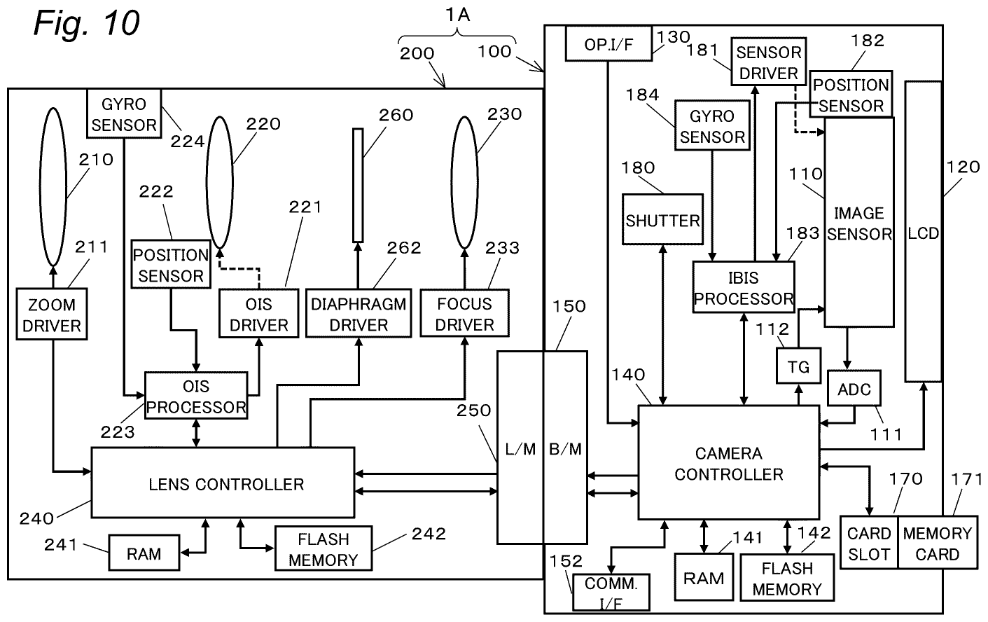

FIG. 10 is a block diagram showing a configuration of the digital camera 1A according to the third embodiment. The digital camera 1A of the present embodiment further includes, for example, a communication interface 152 that performs data communication with the PC 5 according to a predetermined communication standard in the camera body 100, in addition to the configuration similar to that of the first embodiment. The communication interface 152 is an example of an output interface in the digital camera 1A of the present embodiment. As illustrated in FIG. 10, unlike the first embodiment, the digital camera 1A may not include the EIS processor 143 as a functional configuration of the camera controller 140.

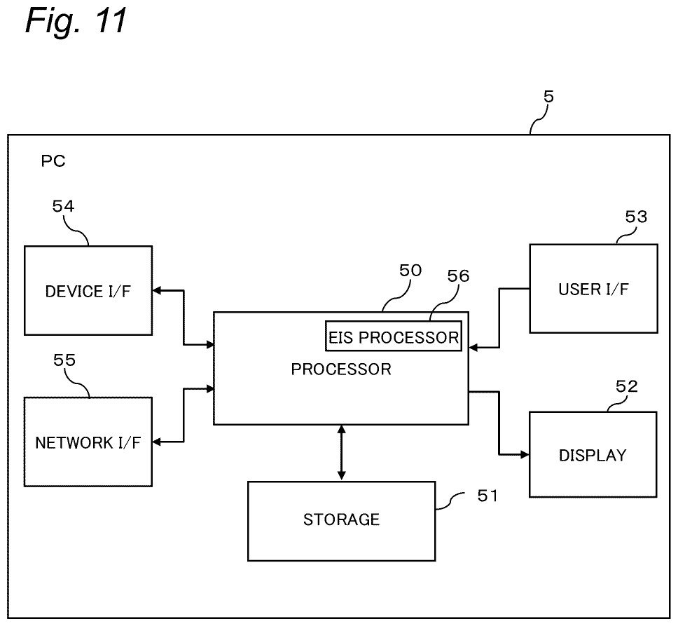

FIG. 11 is a block diagram showing a configuration of the PC 5 in the imaging system 10 of the third embodiment. The PC 5 in FIG. 3 includes a display 52, an user interface 53, a processor 50, a storage 51, a device interface 54, and a network interface 55. Hereinafter, the “interface” is abbreviated as “I/F”.

The display 52 includes, for example, a liquid crystal display or an organic EL display. The display 52 displays an image or the like indicated by the image data received from the digital camera 1. The display 52 may also display various icons for operating the user I/F 53, information input from the user I/F 53, and the like.

The user I/F 53 is a general term for operation members operated by the user. The user I/F 53 includes, for example, a keyboard, a mouse, a touch pad, a button, and/or a switch. The user I/F 53 may constitute a touch panel together with the display 52. When receiving an operation by the user, the user I/F 53 transmits an operation signal corresponding to the user's operation to the processor 50.

The processor 50 is electrically connected to each of the units constituting the PC 5 and controls the operation of these units. The processor 50 includes a CPU and the like, and the CPU executes a program (software) to realize a predetermined function. The processor 50 can be configured by various circuits such as an MPU, a GPU, a DSP, an FPGA, or an ASIC other than the CPU, and may be realized only by a hardware circuit dedicatedly designed to realize a predetermined function. The processor 50 may include an internal memory as a temporary storage area for holding various data and programs.

In the PC 5 of the present embodiment, the processor 50 includes, as a functional configuration, an EIS processor 56 that functions similarly to the EIS processor 143 in the digital camera 1 of the first embodiment, for example.

The storage 51 is a recording medium that stores data, programs, and the like for realizing a predetermined function in the PC 5. The storage 51 includes, for example, a hard disk (HDD), a semiconductor storage device (SSD), a semiconductor memory (RAM), or the like. The storage 51 may function as a work area of the processor 50, or may be configured as a storage area in an internal memory of the processor 50.

The device I/F 54 is a circuit for connecting an external device such as the digital camera 1A to the PC 5. The device I/F 54 performs communication conforming to the USB standard, the Bluetooth (registered trademark) standard, or the like. Under the control of the processor 50, the device I/F 54 according to the present embodiment receives various types of information from the external device such as the digital camera 1, and transmits various types of information to the external device. Similar to the card slot 170 of the digital camera 1A, for example, the device I/F 54 may include a connection circuit for attaching the memory card 171, and may read various information from the memory card 171 or write various information to the memory card 171.

The network I/F 55 is a circuit that performs communication conforming to the communication standard IEEE802.11, the Wi-Fi (registered trademark) standard, or the like. The PC 5 can communicate with other devices directly or via an access point by the network I/F 55. The network I/F 55 may be connectable to a communication network. Each of the device I/F 54 and the network I/F 55 is an example of a data interface in the imaging system 10 of the present embodiment.

The configuration of the PC 5 as described above is an example, and the configuration is not limited to the above example. The data interface of the PC 5 may be realized by cooperation with various kinds of software in the processor 50 or the like, or for example, various kinds of information may be acquired by reading the various kinds of information stored in a recording media such as the memory card 171 to the internal memory of the processor 50. Alternatively, the data interface may acquire such information by generating new data based on various types of data by the processor 50.

### 2. Operation

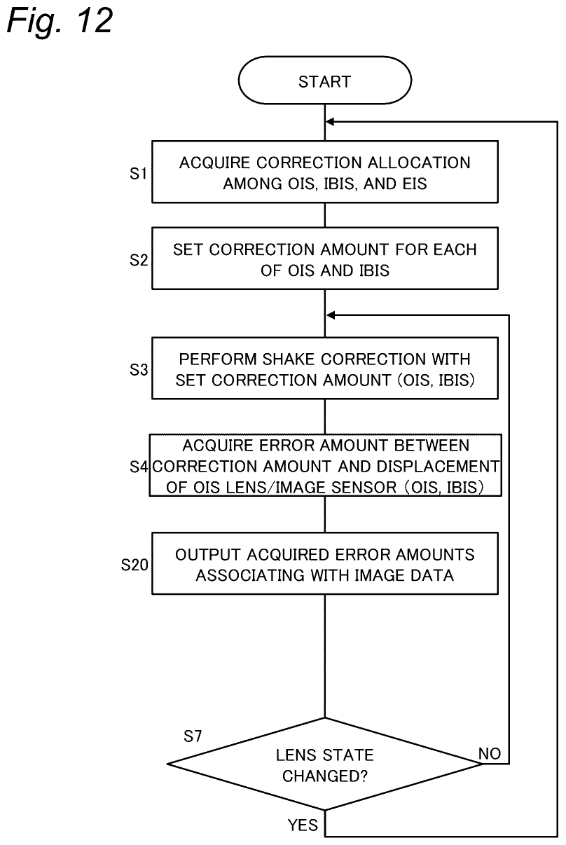

Operations of the imaging system 10 and the digital camera 1A configured as described above will be described with reference to FIG. 12. FIG. 12 is a flowchart illustrating an operation of the digital camera 1A according to the present embodiment.

In the imaging system 10 of the present embodiment, for example, the digital camera 1A acquires the OIS error amount and the IBIS error amount (S4) as in the first embodiment, and then outputs the error amounts, image data generated in image capturing, and the like to the PC 5 instead of setting the EIS correction amount (S5 in FIG. 6) (S20). Specifically, the camera controller 140 associates the correction information including the error amounts with the image data received from the image sensor 110, the image data being buffered in the RAM 141 or the like as a target of the image stabilization by the EIS function, and the camera controller 140 transmits the image data to the PC 5 via the communication interface 152 (S20).

For example, the correction information includes, in addition to each of the error amounts, the EIS ratio set by the correction rate allocator 146 (FIG. 3) and the shake amount calculated from the detection result of the gyro sensor 184. In the present embodiment, the camera controller 140 proceeds the operation to the processing of step S7 without particularly executing the processing of steps S5 and S6 of FIG. 6.

In the PC 5 of the imaging system 10 illustrated in FIG. 9, the processor 50 receives the image data and the correction information output from the digital camera 1A via the device I/F 54, for example. By the processing similar to steps S5 and S6 in FIG. 6, the processor 50 performs, as the EIS processor 56, the setting of the EIS correction amount reflecting each of the error amounts in the received correction information and performs the image stabilizing operation using the EIS correction amount in the image indicated by the image data, similarly to the EIS function of the first embodiment.

According to the imaging system 10 described above, the image stabilizing operation similar to the EIS function is performed in the PC 5 by the EIS correction amount reflecting each error amount in the image stabilizing operation by the OIS function and the IBIS function of the digital camera 1A. This also makes it possible to correct shake on a captured image in consideration of an error caused by the optical image stabilization in the digital camera 1A. The image stabilizing operation in the PC 5 is not limited to be performed when shooting a moving image or the like. For example, image data and correction information may be stored in the storage 51, and the image stabilizing operation may be executed according to the user's operation or the like in the user I/F 53 after shooting.

In the above description, the imaging system 10 outputs the correction information and the image data from the digital camera 1A to the PC 5 in association with each other. The digital camera 1A may output image data with correction information embedded therein as meta information. The digital camera 1A may store the correction information and the image data in an external recording medium such as the memory card 171 via the card slot 170 instead of outputting to the PC 5 via the communication interface 152. In this case, the image stabilizing operation similar to the EIS function can be performed by reading the information and the like stored in the memory card 171 by the PC 5 and the like.

In the above description, the imaging system 10 outputs the correction information including the error amount from the digital camera 1A to the PC 5. The digital camera 1A may include the EIS processor 143 similarly to the digital camera 1 of the first embodiment, or may include a functional configuration that realizes a part of the function of the EIS processor 143. For example, the digital camera 1A may calculate the EIS correction amount and output the EIS correction amount to the PC 5 instead of the error amount.

Further, in the imaging system 10, the digital camera 1A may output the OIS correction amount and the IBIS correction amount to the PC 5 instead of the EIS error amount, or the PC 5 may calculate the EIS error amount based on the correction amounts. For example, the PC 5 of the imaging system 10 may calculate the EIS correction amount by acquiring the position signals from the position sensors 222 and 182 from the digital camera 1 in addition to the correction amounts. The PC 5 may calculate the EIS error amount from each correction amount by simulation processing as described later in a modified example of the third embodiment.

### 3. Summary

As described above, the digital camera 1A according to the present embodiment is an example of an imaging apparatus including the image sensor 110 (image sensor), the optical image stabilizer including at least one of the OIS processor 223 (first image stabilizer) and the IBIS processor 183 (second image stabilizer), the camera controller 140, and the communication interface 152 (output interface) that outputs data. In the present embodiment, Each of the OIS processor 223, the IBIS processor 183, and the camera controller 140 is an example of a controller that controls image stabilization by the optical image stabilizer. The image sensor 110 captures a subject image formed via the optical system to generate image data. The OIS processor 223 performs the image stabilization by moving the OIS lens 220 (correction lens) included in the optical system in the plane perpendicular to the optical axis of the optical system. The IBIS processor 183 performs the image stabilization by moving the image sensor 110 in the plane perpendicular to the optical axis. The OIS processor 223, the IBIS processor 183, and the camera controller 140 set the OIS correction amount and the IBIS correction amount each as an example of the shake correction amount to be corrected by the optical image stabilizer for the shake amount of the digital camera 1 (S2 in FIG. 6). The camera controller 140 cause the communication interface 152 to output, in association with the image data generated by the image sensor 110, the set OIS correction amount and the set IBIS correction amount, or the OIS error amount and the IBIS error amount. The OIS error amount and the IBIS error amount are examples of the error amount indicating a difference between each of the correction amounts and the displacement of the OIS lens 220 or the image sensor 110 moved in the image stabilization by the optical image stabilizer.

According to the digital camera 1A described above, the OIS/IBIS error amount or the OIS/IBIS correction amount in the optical image stabilizing operation is output together with the image data. Therefore, it is possible to facilitate, based on each of the error amounts or each of the correction amounts output from the digital camera 1A, for example, the image stabilization reflecting each of the error amounts in the image data can be easily performed by the external PC 5 or the like.

In the present embodiment, the imaging system 10 includes the device I/F 54 (data interface), the EIS processor 56, and the processor 50 in the PC 5 (see FIG. 11). By the device I/F 54, the PC 5 acquires data output from the digital camera 1A, the data including the OIS correction amount and the IBIS correction amount (shake correction amount) to be corrected by the optical image stabilizer, or the OIS error amount and the IBIS error amount, and the image data output from the digital camera 1A. The EIS processor 56 performs the image stabilization by adjusting an area from which an image indicated by the image data is cropped. The processor 50 controls the image stabilization by the EIS processor 56. The processor 50 sets the EIS correction amount as an example of the shake correction amount to be corrected by the EIS processor 56, based on the OIS correction amount and the IBIS correction amount by the optical image stabilizer, or based on the OIS error amount and the IBIS error amount. The EIS processor 56 performs the image stabilization by the set EIS correction amount.

According to the above imaging system 10, for example, similarly to the EIS processor 143 in the digital camera 1 of the first embodiment, the PC 5 can perform the image stabilizing operation reflecting the error in the optical image stabilization, and can easily correct the camera shake even when a significant camera shake occurs.

### Modified Example of Third Embodiment

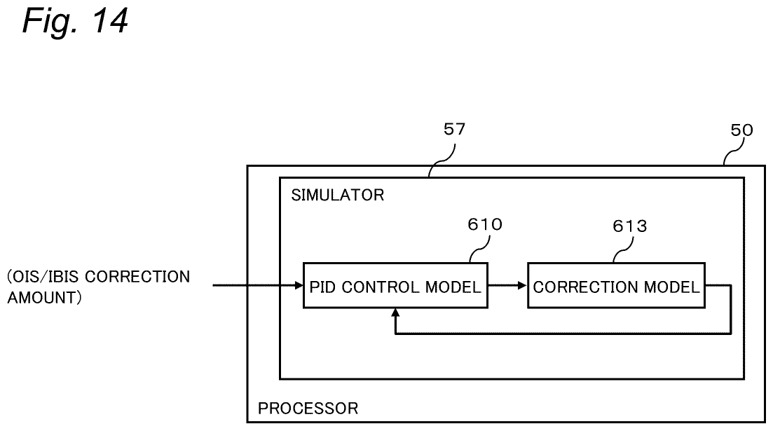

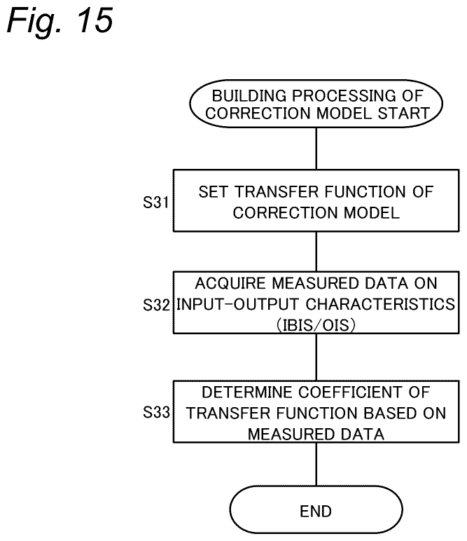

In the third embodiment described above, as in the first embodiment, the digital camera 1A calculates the OIS error amount based on the OIS correction amount and the position signal from the position sensor 222 (FIG. 3), and calculates the IBIS error amount based on the IBIS correction amount and the position signal from the position sensor 182 (FIG. 4). For example, the error amounts may be calculated from the respective correction amounts by simulation processing without using the position signal. Such a modified example of the third embodiment will be described with reference to FIGS. 14 and 15.

The imaging system of the present modified example includes a simulator 57 that executes the above-described simulation processing as a functional configuration in the processor 50 of the PC 5. FIG. 14 is a block diagram showing a configuration of a simulator in an imaging system according to a modified example of the third embodiment. The simulator 57 includes a PID control model 610 that performs a numerical operation similar to that of the PID controller 410 (FIG. 3) or the PID controller 310 (FIG. 4), and a correction model 613 that simulates the operation of the IBIS processor 183, the OIS processor 223, or the like. The correction model 613 may simulate operations including the operation of the position sensor 182 or the position sensor 222, and the operation of sensor driver 181 or the OIS driver 221.

For example, the processor 50 as the simulator 57 acquires the OIS correction amount or the IBIS correction amount in response to a request to the camera controller 140 via the device I/F 54 or the like. Hereinafter, the simulation of the IBIS function will be described as an example, but simulation of the OIS function can also be performed similarly to the present example. In addition, simulation may be performed only for one of the OIS function and the IBIS function.

The simulator 57 of the present example inputs the IBIS correction amount to the PID control model 610 to output a signal corresponding to a drive signal to the sensor driver 181, and inputs the signal to the correction model 613 to output position information corresponding to a position signal from the position sensor 182. In the present modified example, the processor 50 acquires, as the IBIS error amount, deviation calculated based on the IBIS correction amount and the position information from the correction model 613 in the PID control model 610. The processor 50 may directly calculate the IBIS error amount based on the IBIS correction amount and the positional information from the correction model 613, without being limited to the deviation.

According to the simulation processing as described above, for example, in the PC 5, calculating the error amount by acquiring the correction amount by the IBIS function or the like and the image data in capturing the moving image from the digital camera 1, the image stabilization by the EIS correction amount including the error amount can be applied to the image data.

FIG. 15 is a flowchart illustrating a building processing of the correction model 613 of the imaging system according to the modified example of the third embodiment. The processing of this flowchart is executed by the processor 50 of the PC 5, for example, before a processing executed by the simulator 57.

The processor 50 sets a transfer function representing characteristics (e.g., frequency characteristics) on the operation of the sensor driver 181 in the correction model 613 (S31). For example, as the transfer function, information indicating a function is stored in advance in the storage 51, the function corresponding to twice integration to output a position where the image sensor 110 is moved when inputting a force for driving the image sensor 110 according to the drive signal from the sensor driver 181. The information may be input by the user's operation on the user I/F 53. The information may include initial values of various coefficients included in the transfer function. In step S31, the processor 50 sets the transfer function with reference to such information.

The processor 50 acquires, from the storage 51 or the like, measurement data indicating a measurement result measured in advance for input-output characteristics such as a relationship between a drive signal input to the sensor driver 181 and a position signal of the image sensor 110 output from the position sensor 182 (S32). For example, in the time domain, such input-output characteristics are measured by inputting a white noise signal to the sensor driver 181 and acquiring a position signal from the corresponding position sensor 182. Furthermore, for example, in the frequency domain, the measurement is performed by repeating, for a plurality of frequencies, the processing to calculate an amplification factor (gain) of an output signal with respect to an input signal on the basis of the position signal output from the position sensor 182 when a single frequency signal is input to the sensor driver 181.

On the basis of the measurement data, the processor 50 determines a coefficient of the transfer function by a least squares method or the like so as to minimize an error between an output signal by the transfer function when an input signal similar to the measurement data is input to the transfer function and a position signal corresponding to the input signal in the measurement data (S33). For example, a linear or non-linear least squares method can be used. The processor 50 stores the determined coefficient in the storage 51 or the like.

According to the above processing, for example, the correction model 613 can be built as the transfer function that simulates the position of the image sensor 110 moved by the sensor driver 181 in the IBIS function (or the displacement from the position before movement). Similar to the above processing, the correction model 613 can also be built as a function of simulating the position (or displacement) of the OIS lens 220 driven by the OIS driver 221 in the OIS function. The transfer function may be represented not only in the continuous time domain but also in the discrete time domain. The correction model 613 is not limited to the transfer function, and may be represented by a state equation.

Furthermore, in the imaging system of the present modified example, the digital camera may include various sensors (e.g., an acceleration sensor) for detecting an impact from the outside. In this case, the correction model 613 may be built to further input an output signal of the sensor and output a corresponding position signal. In addition, the above processing is not limited to be calculated by the processor 50 of the PC 5, and a part or all of the processing may be executed by the camera controller 140 or the like in the digital camera 1A. That is, the above-described simulation processing may be executed in the digital camera.

As described above, in the imaging system of the present modified example, the processor 50 controls the simulation processing of predicting at least one of the displacement of the OIS lens 220 and the displacement of the image sensor 110 at the time of the image stabilization by the optical image stabilizer on the basis of the OIS correction amount and/or the IBIS correction amount (an example of the shake correction amount to be corrected by the optical image stabilizer). Therefore, for example, even when the PC 5 receives each of the correction amounts instead of the OIS error amount and/or the IBIS error amount, the imaging system can calculate each of the corresponding error amount using only each of the correction amounts at the time of prediction.

### Other Embodiments

The first to the third embodiments are described above as the examples of the technique disclosed in the present application. However, the technique in the present disclosure is not limited thereto, and can also be applied to embodiments in which changes, substitutions, additions, omissions, and the like are made as appropriate. In addition, it is also possible to combine the components described in the first to the third embodiments to provide a new embodiment. Therefore, other embodiments will be exemplified below.

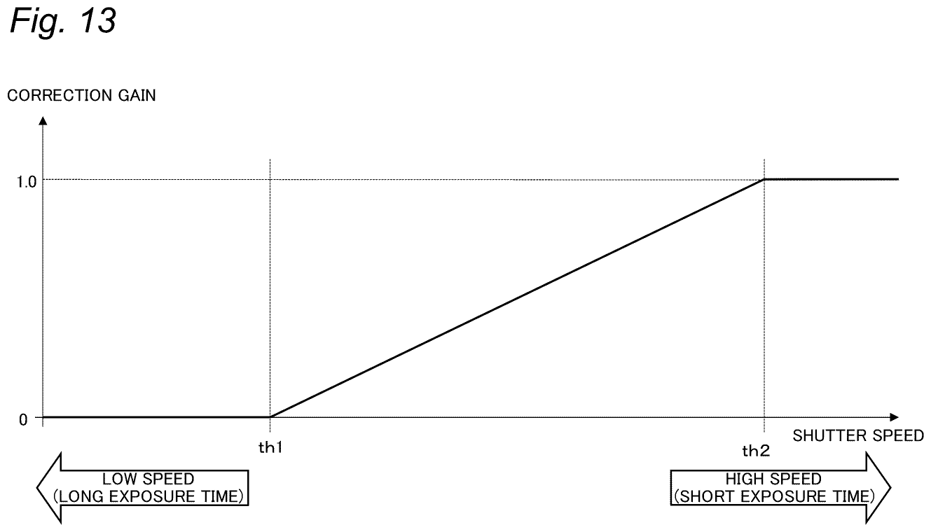

In the first embodiment described above, in the digital camera 1, the camera controller 140 sets the EIS correction amount on the basis of the shake detection signal, the EIS ratio, the OIS error amount, and the IBIS error amount (S5 in FIG. 6). The camera controller 140 may further set the EIS correction amount on the basis of the shutter speed of the shutter 180. Such a modified example of the first embodiment will be described with reference to FIG. 13.

FIG. 13 is a diagram for illustration of the operation of the digital camera according to the modified example of the first embodiment; The digital camera of the present modified example has the similar configuration to that of the digital camera 1 of the first embodiment. When the EIS correction amount is set, the camera controller 140 adjusts the correction amount for each of the error amounts acquired in step S4 according to the shutter speed, for example, in a process similar to step S5 in FIG. 6. FIG. 13 illustrates a relationship between a correction gain indicating a ratio for adjusting such a correction amount and a shutter speed. The correction gain is preset as a real number of “0” or more and “1” or less.

In the example of FIG. 13, when the shutter speed becomes slower than a threshold value th2 that can be regarded as a relatively high speed (i.e., the exposure time is short), the correction gain decreases linearly, and when the shutter speed is a threshold value th1, the correction gain is set to be “0”. For example, the camera controller 140 adjusts so as to reduce the correction amount in a case where the shutter speed is slower than the threshold value th2 by multiplying the correction amount for each error amount by the correction gain. Therefore, the EIS correction amount can be set such that the correction amount with respect to the error amount is increased in an image captured at a relatively high shutter speed, reflecting that the image stabilization of the EIS function can be easily performed accurately in such image, and the correction amount is decreased in an image with a relatively low shutter speed.

The correction gain is not limited to the example of FIG. 13, and for example, may be set to decrease nonlinearly in accordance with a decrease in shutter speed, or a minimum value may be set to a value larger than “0” (e.g., “0.8”). In FIG. 13, an example in which a maximum value of the correction gain is “1” is described, but the maximum value of the correction gain may be, for example, less than “1” or may be a real number exceeding “1”.

In the third embodiment described above, the PC 5 is described as an example of the information processing device in the imaging system 10, but the information processing device may be various server computers or the like. In the present embodiment, for example, the digital camera 1A may transmit image data and correction information to a server computer on a communication network via the communication network such as the Internet. In this case, the image stabilizing operation of the EIS function may be executed based on the image data and the correction information received by the server computer, or the PC 5 may acquire the image data and the correction information from the server computer instead of the digital camera 1A of the third embodiment. The information processing device may be realized by distributed computing or the like.

In each of the above embodiments, the digital camera including the gyro sensor 184 that detects the camera shake of the camera body 100 and the gyro sensor 224 that detects the camera shake of the interchangeable lens 200 is described each as an example of the camera shake detector. In the present embodiment, the digital camera may include an acceleration sensor on at least one of the camera body 100 and the interchangeable lens 200 as a shake detector instead of the gyro sensor 184, 224. For example, the IBIS processor 183 or the OIS processor 223 may calculate the twice integration of acceleration detected by the acceleration sensor as displacement of the shake (vibration), and calculate the IBIS correction amount or the OIS correction amount on the basis of the displacement.

In the above embodiment, the digital camera using the acceleration sensor as an example of the shake detector is described. In the digital camera of the present embodiment, the acceleration sensor may be attached so as to detect the acceleration of the OIS lens 220 or the image sensor 110 that is moved by the image stabilizing operation. For example, instead of the position signal from the position sensor 222, 182, the lens controller 240 or the camera controller 140 of the present embodiment may calculate the position information of the OIS lens 220 or the image sensor 110 by the twice integration of the detected acceleration on the basis of the detection result of the acceleration sensor.

The above embodiments describe the digital cameras 1 and 1A in which the position sensor 182 of the camera body 100 detects the position in the rotation direction by the rotation axis along the optical axis in addition to the two orthogonal axes (X axis, Y axis) directions of the image sensor 110. In the digital camera of the present embodiment, the position sensor of the camera body 100 may detect only the positions in the X-axis direction and the Y-axis direction according to translation from the reference position of the image sensor 110.

The above embodiments describe the digital camera that performs the image stabilizing operation by the EIS function when capturing a moving image or the like. For example, the digital camera of the present embodiment may perform the image stabilizing operation using the EIS function after capturing by acquiring the OIS error amount and/or the IBIS error amount (S4) and then storing the OIS error amount and/or the IBIS error amount in association with the image data obtained from the image sensor 110. For example, when a moving image indicated by image data is reproduced, the correction by the EIS function may be performed by reading the error amount associated with the image data. In addition, not limited to the error amount, for example, the OIS and IBIS correction amounts and the position signals from the corresponding the position sensors 222 and 182 may be stored together with the image data, and the error amount may be calculated at the time of the correction by the EIS function.

The above embodiments describe the example in which the OIS/IBIS error amount is calculated by (1) the deviation used in the PID controller 310, 410, (2) the difference between the OIS/IBIS correction amount and the position information of the OIS lens 220 or the image sensor 110, or (3) the simulation. Each of the error amounts may be calculated by a combination of two or more of the above (1) to (3), or may be calculated in consideration of an influence on each error amount due to an impact from the outside of the digital camera using an acceleration sensor or the like. Furthermore, in the present embodiment, for example, each of the error amounts may be calculated by arithmetic processing for numerical prediction by artificial intelligence such as machine learning on the basis of a signal indicating a detection result of deviation and acceleration, and/or image data, and the like as described above.

The above embodiments describe the digital camera that acquires the OIS/IBIS error amount (S4) while repeating the operation of FIG. 6 or 7 in a predetermined period such as a frame period, and performs the image stabilizing operation by the EIS function using the error amount. In the present embodiment, the camera controller 140 may acquire each of the error amounts in a period corresponding to the exposure timing of the shutter 180, for example, and execute the image stabilizing operation of the EIS function using the error amount according to the exposure timing. Therefore, for example, image distortion due to the rolling shutter phenomenon can be suppressed.

The above embodiments describe the digital camera of an interchangeable lens type as an example of the imaging apparatus, but the imaging apparatus of the present embodiment may be a digital camera that is not of an interchangeable lens type particularly. Furthermore, the idea of the present disclosure can be applied not only to a digital camera but also to a movie camera or an electronic device having various imaging functions such as a camera-equipped mobile phone, a smartphone, or a PC.

As described above, the embodiments are described as the examples of the technique in the present disclosure. For this purpose, the accompanying drawings and the detailed description are provided.

Therefore, the components described in the accompanying drawings and the detailed description may include not only components essential for solving the problem but also components that are non-essential for solving the problem in order to illustrate the above technique. Therefore, it should not be immediately recognized that these non-essential components are essential based on the fact that these non-essential components are described in the accompanying drawings and the detailed description.

In addition, since the above-described embodiments are intended to illustrate the technique in the present disclosure, various changes, substitutions, additions, omissions, and the like can be made within the scope of the claims or equivalents thereof.

### Summary of Aspects

Various aspects according to the present disclosure are listed hereinbelow.

A first aspect according to the present disclosure is an imaging apparatus, including: an image sensor configured to capture a subject image formed via an optical system to generate image data;
an optical image stabilizer including at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis;
a third image stabilizer configured to perform image stabilization by adjusting an area from which an image indicated by the image data is cropped; and
a controller configured to control the image stabilization by the optical image stabilizer and the third image stabilizer, wherein
the controller is configured to
set a shake correction amount to be corrected by the optical image stabilizer for an amount of shake of the imaging apparatus; and
set a shake correction amount to be corrected by the third image stabilizer, based on an error amount indicating a difference between the shake correction amount set to the optical image stabilizer and a displacement of one of the correction lens and the image sensor moved in the image stabilization by the optical image stabilizer, and the third image stabilizer is configured to perform the image stabilization based on the set shake correction amount.

A second aspect is the imaging apparatus according to the first aspect, further including a shake detector configured to detect the amount of shake of the imaging apparatus, wherein
one of the first image stabilizer and the second image stabilizer is configured to perform the image stabilization on the amount of shake detected by the shake detector according to the shake correction amount set to the corresponding image stabilizer.

A third aspect is the imaging apparatus according to the first or second aspect, further including a position detector configured to detect a position of the correction lens or a position of the image sensor in the plane perpendicular to the optical axis, wherein
the controller is configured to acquire, based on a detection result by the position detector, at least one of the displacement of the correction lens and the displacement of the image sensor.

A fourth aspect is the imaging apparatus according to any of the first to third aspects, wherein the controller is configured to
calculate, based on image data sequentially captured by the image sensor, a motion vector of the subject image in an image represented by the image data, and
set the shake correction amount to be corrected by the third image stabilizer, by switching between a shake correction amount according to the error amount and a shake correction amount according to the calculated motion vector.

A fifth aspect is the imaging apparatus according to any of the first to fourth aspects, wherein the controller is configured to calculate the error amount for at least one direction of: two orthogonal directions in the plane perpendicular to the optical axis; and a rotation direction around a rotation axis along the optical axis.

A sixth aspect is the imaging apparatus according to any of the first to fifth aspects, further including an interchangeable lens including the optical system and the first image stabilizer;
a camera body including the image sensor and the third image stabilizer; and
a communication interface configured to perform data communication between the interchangeable lens and the camera body, wherein
the controller is configured to
receive, from the interchangeable lens via the communication interface, at least one of the shake correction amount set to the first image stabilizer and the error amount in the image stabilization by the first image stabilizer.

A seventh aspect according to the present disclosure is an imaging apparatus, including: an image sensor configured to capture a subject image formed via an optical system to generate image data;
an optical image stabilizer including at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis;
a controller configured to control the optical image stabilizer; and
an output interface configured to output data, wherein
the controller is configured to
set a shake correction amount to be corrected by the optical image stabilizer for an amount of shake of the imaging apparatus; and
cause the output interface to output, in association with the image data, the shake correction amount set to the optical image stabilizer, or an error amount indicating a difference between the shake correction amount set to the optical image stabilizer and a displacement of one of the correction lens and the image sensor moved in the image stabilization by the optical image stabilizer.

A eighth aspect according to the present disclosure is an imaging system, including: a data interface configured to acquire data output by the imaging apparatus according to the seventh aspect, the data including the image data, and one of the shake correction amount to be corrected by the optical image stabilizer and the error amount and;
a third image stabilizer configured to perform image stabilization by adjusting an area from which an image indicated by in the image data is cropped; and
a processor configured to control the image stabilization by the third image stabilizer, wherein
the processor is configured to set a shake correction amount to be corrected by the third image stabilizer, based on the shake correction amount to be corrected by the optical image stabilizer or the error amount, and
the third image stabilizer is configured to perform the image stabilization by the set shake correction amount.

A ninth aspect is the imaging system according to the eighth aspect, wherein the processor is configured to
control simulation processing predicting, based on the shake correction amount to be corrected by the optical image stabilizer, at least one of the displacement of the correction lens and the displacement of the image sensor moved in the image stabilization by the optical image stabilizer.

The concept of the present disclosure can be applied to an electronic device (e.g., imaging apparatuses such as digital cameras, camcorders, mobile phones, smartphones, and the like) having an image shooting function provided with an image stabilizing function.

What is claimed is:

1. An imaging apparatus comprising:
an image sensor configured to capture a subject image formed via an optical system to generate image data;
an optical image stabilizer including at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis;
a third image stabilizer configured to perform image stabilization by adjusting an area from which an image indicated by the image data is cropped; and
a controller configured to control the image stabilization by the optical image stabilizer and the third image stabilizer, wherein
the controller is configured to
set a shake correction amount to be corrected by the optical image stabilizer for an amount of shake of the imaging apparatus; and
set a shake correction amount to be corrected by the third image stabilizer, based on an error amount indicating a difference between the shake correction amount set to the optical image stabilizer and a displacement of one of the correction lens and the image sensor moved in the image stabilization by the optical image stabilizer, and
the third image stabilizer is configured to perform the image stabilization based on the set shake correction amount.

2. The imaging apparatus according to claim 1, further comprising:
a shake detector configured to detect the amount of shake of the imaging apparatus, wherein
one of the first image stabilizer and the second image stabilizer is configured to perform the image stabilization on the amount of shake detected by the shake detector according to the shake correction amount set to the corresponding image stabilizer.

3. The imaging apparatus according to claim 1, further comprising:
a position detector configured to detect a position of the correction lens or a position of the image sensor in the plane perpendicular to the optical axis, wherein
the controller is configured to acquire, based on a detection result by the position detector, at least one of the displacement of the correction lens and the displacement of the image sensor.

4. The imaging apparatus according to claim 1, wherein
the controller is configured to
calculate, based on image data sequentially captured by the image sensor, a motion vector of the subject image in an image represented by the image data, and
set the shake correction amount to be corrected by the third image stabilizer, by switching between a shake correction amount according to the error amount and a shake correction amount according to the calculated motion vector.

5. The imaging apparatus according to claim 1, wherein
the controller is configured to calculate the error amount for at least one direction of:
two orthogonal directions in the plane perpendicular to the optical axis; and
a rotation direction around a rotation axis along the optical axis.

6. The imaging apparatus according to claim 1, further comprising:
an interchangeable lens including the optical system and the first image stabilizer;
a camera body including the image sensor and the third image stabilizer; and
a communication interface configured to perform data communication between the interchangeable lens and the camera body, wherein
the controller is configured to
receive, from the interchangeable lens via the communication interface, at least one of the shake correction amount set to the first image stabilizer and the error amount in the image stabilization by the first image stabilizer.

7. An imaging apparatus comprising:
an image sensor configured to capture a subject image formed via an optical system to generate image data;
an optical image stabilizer including at least one of a first image stabilizer and a second image stabilizer, the first image stabilizer performing image stabilization by moving a correction lens included in the optical system within a plane perpendicular to an optical axis of the optical system, the second image stabilizer performing image stabilization by moving the image sensor within the plane perpendicular to the optical axis;
a controller configured to control the optical image stabilizer; and
an output interface configured to output data, wherein
the controller is configured to
set a shake correction amount to be corrected by the optical image stabilizer for an amount of shake of the imaging apparatus; and
cause the output interface to output, in association with the image data, the shake correction amount set to the optical image stabilizer, or an error amount indicating a difference between the shake correction amount set to the optical image stabilizer and a displacement of one of the correction lens and the image sensor moved in the image stabilization by the optical image stabilizer.

8. An imaging system comprising:
a data interface configured to acquire data output by the imaging apparatus according to claim 7, the data including the image data, and one of the shake correction amount to be corrected by the optical image stabilizer and the error amount, and
a third image stabilizer configured to perform image stabilization by adjusting an area from which an image indicated by in the image data is cropped; and
a processor configured to control the image stabilization by the third image stabilizer, wherein
the processor is configured to set a shake correction amount to be corrected by the third image stabilizer, based on the shake correction amount to be corrected by the optical image stabilizer or the error amount, and
the third image stabilizer is configured to perform the image stabilization by the set shake correction amount.

9. The imaging system according to claim 8, wherein
the processor is configured to
control simulation processing predicting, based on the shake correction amount to be corrected by the optical image stabilizer, at least one of the displacement of the correction lens and the displacement of the image sensor moved in the image stabilization by the optical image stabilizer.
